(19) United States
(12) Patent Application Publication
(10) Pub. No.: US 2023/0196482 A1
(43) Pub. Date: Jun. 22, 2023

(54) ELIMINATION OF THE PROTECTED LOADS PANEL THROUGH HARDWARE-ENABLED DYNAMIC LOAD MANAGEMENT

(71) Applicant: Coulomb Inc., Charlottesville, VA (US)

(72) Inventor: Alexander Bazhinov, Charlottesville, VA (US)

(21) Appl. No.: 18/112,531

(22) Filed: Feb. 22, 2023

Related U.S. Application Data
(63) Continuation of application No. 16/881,792, filed on May 22, 2020.
Application No. 16/881,792 is a continuation of application No. 16/580,806, filed on Sep. 24, 2019, now abandoned.
Application No. 16/580,806 is a continuation-in-part of application No. 16/134,094, filed on Sep. 18, 2018, now Pat. No. 10,467,712.
Application No. 16/134,094 is a continuation of application No. 15/874,216, filed on Jan. 18, 2018, now Pat. No. 10,109,987.
(60) Provisional application No. 62/447,847, filed on Jan. 18, 2017.

(51) Int. Cl. G06Q 50/06; H02B 1/24; H02B 1/06; G05B 15/02; H01H 89/06; G06Q 30/0207; H02B 1/056

(52) U.S. Cl. CPC G06Q 50/06; H02B 1/24; H02B 1/066; G05B 15/02; H01H 89/06; G06Q 30/0207; H02B 1/056

(57) ABSTRACT

A simulated protected loads panel system for managing energy consumption and obviating the need to install a physical protected loads panel in conjunction with an energy storage system, comprising a controller, in operable communication with electrical current and/or voltage sensors and relays, which is configured to control the amount of and/or distribution of electrical power from a source of electrical power to an electrical load based on user preference, energy storage system charge, and/or available or anticipated power generation and/or usage.

### CROSS-REFERENCE TO RELATED APPLICATIONS

The present application is a Continuation of and relies on the disclosure of and claims priority to and the benefit of the filing date of U.S. application Ser. No. 16/881,792, filed May 22, 2020, and Ser. No. 16/580,806, filed Sep. 24, 2019, a Continuation-in-Part (CIP) Application of U.S. application Ser. No. 16/134,094, filed Sep. 18, 2018 (published as U.S. Patent Application Publication No. 2019/0019259 on Jan. 17, 2019), which is a Continuation Application of U.S. application Ser. No. 15/874,216, filed Jan. 18, 2018 (published as U.S. Patent Application Publication No. 2018/0205206 on Jul. 19, 2018), which claims the benefit of U.S. Provisional Patent Application No. 62/447,847 filed Jan. 18, 2017, and related to International Application No. PCT/US18/14205, filed Jan. 18, 2018 (published as International Publication No. WO 2018/136615 on Jul. 26, 2018), each of which the '094, '216, and '205 Applications claim priority to and the benefit of the filing date of U.S. Provisional Application No. 62/447,847, filed Jan. 18, 2017. The present application is also related to U.S. application Ser. No. 15/874,825, filed Jan. 18, 2018, which published as U.S. Patent Application Publication No. 2018/0204293 on Jul. 19, 2018 and claims the benefit of U.S. Provisional Patent Application No. 62/447,847, and the present application is related to International Application No. PCT/US18/14291, filed Jan. 18, 2018, which published as International Publication No. WO 2018/136672 on Jul. 26, 2018, both of which '825 and '291 Applications claim priority to and the benefit of the filing date of U.S. Provisional Application No. 62/447,847, filed Jan. 18, 2017. The disclosure of each of these applications, publications, and patents is incorporated by reference herein in their entirety.

### BACKGROUND

### Field of the Invention

The present invention relates to customer energy management, grid-edge innovation and dynamic energy distribution, as well as energy grid intelligence.

The present invention is directed to a next-generation Simulated Protected Loads Panel (SPLP) to improve the consumer economics of residential energy storage products and to allow for continued expansion of distributed energy resources. The invention may also be employed in applications involving commercial products and/or generators. Dynamic load management algorithms according to the present invention serve to eliminate the need for hard-wired sub panels (also interchangeably referred to as protected loads panels, backup loads panels, critical loads panels, etc.) to be installed along with backup power/energy systems, including energy storage systems (ESS), generators, etc., providing homeowners and others with significantly greater flexibility during off-grid operation.

Rather than deciding which circuits to energize in the event of a grid outage (pre-determined due to hard-wiring those choices into a sub-panel upon installation), embodiments of the present invention allow homeowners and others the ability to prioritize and choose which circuits, loads, appliances, and/or other downstream electricity consumption to energize or de-energize dynamically. (Loads can generally be used to include or refer to circuits, appliances, outlets, microgrids, premises, and/or other downstream electricity consumption.) Such choices allow a consumer to respond/consume/conserve according to changing circumstances, differing grid-outage scenarios, and fluid temporal preferences. According to the present invention, during a grid outage, for example, a homeowner or other electricity consumer can identify which circuits, loads, appliances, and/or other energy consumption system or apparatus, to prioritize and energize, for example, according to the amount of available energy, anticipated solar photovoltaic (PV) or other energy generation output, and/or expected consumption. Rather than leaving the alignment of ESS charge, solar PV or other energy generation output, and household consumption to chance, or other dynamics, embodiments of the invention can optimize household consumption allowances based on available ESS charge and/or data-driven predictions of PV output or other energy generation and/or baseline household consumption needs. When household loads are connected to a traditional protected loads panel without energy management, they are “ungovernable” and their collective power demand may reach excessive levels, despite user preference to the contrary. In embodiments, the invention can change the function of ESS systems during off-grid operation, dramatically increasing the value and flexibility of residential energy storage systems.

### Description of Related Art

Existing energy monitoring and control systems are available in several varieties. For example, there exist energy management systems that are embedded into circuit breaker panels. Such systems allow for monitoring and control of energy consumption on individual circuits, however, installation of such a system usually requires a full electrical panel replacement or deep panel retrofit. Typically, consumers purchase a new circuit breaker panel with built-in energy management functions to replace the entire existing circuit breaker panel or larger parts of such panel with the purchased system.

There are also energy monitoring systems that can be installed inside a circuit breaker panel. Typically, such systems include a controlling unit and current transformers (CTs) or other non-intrusive load monitoring (NILM) technology installed inside an existing circuit breaker panel. With such systems, a consumer can monitor energy consumption on a main feed level or on a circuit-by-circuit level, however, these systems only allow for monitoring of energy consumption by each circuit or groups of circuits due to the CTs (responsible for energy monitoring) being disposed and configured to measure electrical current without intrusive or in-line physical connection to conductors/wires.

Other energy monitoring and controlling systems are designed to manage energy consumption on a device level. In such systems, a plurality of devices are typically installed in close proximity to the measured electric load (relatively far from the circuit breaker panel) and usually connected to an electric outlet to measure and control electricity consumption of device(s) connected to that outlet. Such systems are not capable of managing energy consumption in a given premises (whole-house, by way of example only) and only provide limited information by individual electric load. In some cases, for example with hardwired lighting and HVAC systems, this type of system lacks the ability to obtain a full and comprehensive depiction of energy consumption since these types of electric loads do not use traditional electric sockets.

In the particular case of installing an ESS, the state of the art typically is to remove several circuits from the main service panel (in aspects an electrical service panel) and wire them into a sub-panel, such that they can remain operational during grid outages. To address the shortcomings of the state-of-the-art technology, embodiments of the invention of the current application provide a simulated protected loads panel (SPLP) that will obviate the need for a hard-wired sub-panel through software-driven dynamic behind-the-meter load management. “Behind-the-meter” has meaning to one of ordinary skill in the art and generally refers to any grid or micro-grid, electrical circuits, loads, appliances, electrical panels, outlets, and/or other equipment, located downstream of the utility meter.

Due to capacity and energy limitations of ESS systems, when installing a storage system, typically, a sub-panel, separate service panel, backup loads panel, or protected loads panel is installed to house the critical circuits that the homeowner wishes to energize via battery power when the grid is down.

On the other hand, the system of the current invention functions such that when power goes out, a transfer switch prevents stored energy from being fed back onto the grid, and the ESS energizes the circuits that were wired into the sub-panel during installation. Every circuit that is not wired into the sub-panel will have no power, meaning that only a minority of load-side appliances will be operable until grid power is restored, despite the capability to produce and store energy with PV and RES. If critical circuits were not segregated in a separate sub-panel, the battery would be unable to adequately power all circuits on the main service panel, causing appliances to be inadequately powered and brown out. This is not only disruptive, but can also be damaging to certain appliances and the battery. At present, the only remedy for this situation is for the homeowner to purchase and install a sufficiently large PV array and ESS to power their entire home when the grid is down, which in many cases is cost-prohibitive.

According to currently available technology, a homeowner is forced to accept that most of their home will not have power during off-grid operation, despite their investment in PV and RES. Moreover, the homeowner is forced into a pre-determined assignment of electricity use and must choose in advance which circuits they would like to feed during off-grid operation and hard-wire those choices into a sub-panel. Should needs or preferences change, the homeowner currently has to schedule an electrician to re-wire their sub-panel with the new circuit, and very likely trade out a circuit that was previously wired into the sub-panel. Even this solution is incomplete, because the power demand equivalency between the old circuit and the new circuit is unlikely to match exactly. Retroactively trading one circuit for another in a physical sub-panel without adjusting the capacity/size of the storage system can recreate the issue of inadequate power supply.

The present invention provides an innovative approach—as far as the inventors are aware, no other technology is attempting to replace the functionality of a sub-panel through demand-side dynamic load management, nor is any technology attempting to measure and control electricity via direct insertion of, for example, electrical current and/or voltage sensors (and/or hall effect sensors) and, for example, relays (which may be, in aspects, mechanical relays) into each line exiting the main service panel. The only approaches to expanding off-grid operation of ESS systems are (1) to install a battery or energy storage system with more capacity, or to install multiple energy storage systems with stackable inverters; or (2) to rely on user-controlled load reduction. Installing a larger storage system or multiple storage systems with stackable inverters is a high-cost approach to achieving off-grid flexibility and does not fully capitalize on the potential value of the ESS. The second, user-controlled, approach may be a cost-effective method of conserving power during off-grid operation, but does not expand the menu of circuits available for use, which is the main challenge that the SPLP is addressing. The second approach also exposes the user to the risk of excessive power demand, which in certain cases may cause the circuit breaker in the inverter to trip, resulting in loss of power in the home.

Additionally, according to the current invention, collecting disaggregated whole-home consumption data through electrical current and/or voltage sensors (which in aspects may be hall effect sensors) is a novel approach, as other available solutions rely on current transformers (CTs) to measure the flow of electricity. Apart from being inherently less accurate, CTs around the main service feed require complex data science work in order to isolate a single appliance from the noise of whole-home consumption. In contrast, in embodiments of the current invention, the approach to data collection via electrical current and/or voltage sensors can allow for the capability of skipping the prerequisite step of cleaning and disaggregating data. The present invention can also be used to leverage the existing circuit breaker panel instead of requiring a redundant sub-panel to be installed at significant cost to the homeowner. In such a situation, all functionality of the circuit breakers can be caused to remain in place; this is important from a regulatory standpoint, as circuit breakers are tightly regulated and any change to the functionality requires an extensive approval process.

At present, energy storage for whole-home off-grid operation is prohibitively expensive. The publication Ardani, Kristin, Eric O'Shaughnessy, Ran Fu, Chris McClurg, Joshua Huneycutt, and Robert Margolis. “Installed Cost Benchmarks and Deployment Barriers for Residential Solar Photovoltaics with Energy Storage: Q1 2016.” National Renewable Energy Laboratory, NREL/TP-7A40-67474 (2017) (https://www.nrel.gov/docs/fy17osti/67474.pdf), estimates that the cost difference between a 3 kW/6 kWh ESS and a 5 kW/20 kWh ESS is roughly $17,500: a 60-63% premium for the larger system. The choice to opt for the larger system is largely driven by a desire for increased off-grid functionality. The authors suggest that “users [who] are willing to pay a premium for larger PV-plus-storage systems” are willing to do so because those systems have “enhanced back-up power capabilities.” The state-of-the-art in ESS sizing depends on a homeowner's desired off-grid operation. The size of the ESS corresponds directly to the number of circuits a user/consumer wishes to energize, and is dictated by the estimated maximum potential power draw of each of those circuits. If a user wishes to energize additional circuits, then a larger and more expensive ESS is needed to accommodate those preferences. Large up-front premium payments for future functionality is unattractive, and is a hindrance to ESS sales and distributed-generation PV (DGPV) growth.

According to embodiments of the present invention, the SPLP fundamentally changes this calculus by allowing homeowners to opt for the smaller system with functionality that mimics that of the larger system through off-grid flexibility. This technology is crucial to the continued expansion of DGPV installations in two major ways: (i) ESS systems convert DGPV from a variable resource into a dispatchable resource, removing the challenge of diminishing marginal value faced by variable resources, and (ii) whereas standalone, grid-tied DGPV systems cannot produce energy when the grid is down, adding an ESS and SPLP will enable off-grid production and flexible consumption. These benefits are documented, but prohibitively high ESS costs continue to impede expansion of the ESS installation base, which in turn is a major impediment to the expansion of DGPV.

### SUMMARY

The present invention provides devices, systems and methods for managing electrical energy consumption by way of demand-side dynamic load management. Devices, systems and methods according to embodiments effectively replace the functionality of a sub-panel and/or obviate the need for a sub-panel.

Provided in embodiments is a simulated protected loads panel (SPLP) system for managing energy consumption. The SPLP comprises a controller configured to control the amount of and/or distribution of electrical power from a source of electrical power to an electrical load based on user preference, energy storage system state of charge, and/or available power. In embodiments, the controller is in operable communication with electrical current and/or voltage sensors and relays to enable control of the amount and/or how the electrical power is distributed to the loads/appliances.

Systems for demand-side management of off-grid energy consumption are provided, comprising: a simulated protected loads panel (SPLP) configured for operable connection with an electrical service panel associated with multiple electrical circuits and loads, an off-grid energy generation and/or storage source or system (such as a battery or residential energy storage system), and a residential energy storage (RES) system; and one or more electrical current and/or voltage sensors and relays configured for direct connection with one or more or each of the multiple electrical circuits and loads; wherein the SPLP comprises an interactive user portal with application programming interface (API) configured for integration to the ESS, an ESS charge controller and/or an inverter.

In such systems, the off-grid energy harvesting source, power generation device, or energy storage device can be a solar photovoltaic (PV) array, and/or an energy storage system, and/or other energy generation source.

In preferred embodiments, and when installed at a user's premises, at least one of the electrical current and/or voltage sensors and at least one of the relays can be directly connected to each of the multiple electrical circuits on an electrical line exiting the electrical service panel.

The application programming interface (API) can comprise computer-executable instructions configured to ingest, store, and/or enact user preferences tied to electrical power outage events.

In systems, devices, and methods of the invention, the electrical current and/or voltage sensors can be disposed in a manner to allow for collecting electrical consumption data relating to individual appliances, such as providing for collection of electrical consumption data without cleaning and disaggregating whole-house consumption data.

In embodiments, the SPLP can be configured to provide for a choice in which of the multiple electrical circuits, loads, appliances, and/or other downstream electricity consumption to energize, such as without using an electrical sub-panel.

SPLPs (simulated protected loads panels) according to embodiments of the invention can be installed in lieu of a hard-wired sub-panel and/or installed as a retrofit replacement for a pre-existing sub-panel. To capture the full value from the SPLP, it can be installed at the same time as the ESS (energy storage system) so that no hard-wired sub-panel ever needs to be installed, trading the expense of installing a static sub-panel for the improved economics of installing a SPLP.

In embodiments, the SPLP technology is capable of allowing users to determine dynamically and flexibly which circuits to energize during a grid outage based on the cause and expected duration of the outage, expected PV output, and expected household consumption, with the ability to determine which appliances and modes of operation are available to a user under the given constraints.

The SPLP can be configured to allow a user to respond dynamically to changing circumstances, differing grid-outage scenarios, and/or temporal preferences.

In cooperation with relays, which in cases may be mechanical relays, the SPLP can be configured to provide for a choice in which of the multiple electrical circuits, loads, appliances, and/or other downstream electricity consumption to energize, while maintaining functionality of all of the multiple electrical circuits.

In embodiments, the SPLP and API together can be configured to provide for identifying which circuits, loads, appliances, and/or other energy consumption system or apparatus to prioritize and/or energize, such as according to an amount of available energy, anticipated PV output, and/or expected consumption.

The SPLP and API together can be configured to allow for optimizing household consumption allowances based on available ESS charge and data-driven predictions of PV output and baseline household consumption needs.

Included within the scope of the invention are systems for managing energy consumption comprising: one or more electrical current and/or voltage sensor and one or more relay in operable communication with one or more circuit electrically connecting one or more electrical load with one or more source of electrical power; one or more controller, in operable communication with the one or more electrical current and/or voltage sensor and the one or more relay, which is configured to control, sense, and/or manage the amount of and/or distribution of electrical power from one or more of the sources of electrical power to one or more of the electrical loads based on one or more or all of user preference, residential energy storage (RES) system charge, and/or available power; one or more processing unit, in operable communication with one or more of the controllers, which is capable of receiving, processing, storing, and/or communicating information and/or calculations received from and/or derived from one or more of the electrical current and/or voltage sensors and sending instructions to and/or receiving information from one or more of the controllers based on the information and/or calculations received from and/or derived from one or more of the electrical current and/or voltage sensors; one or more link for wired or wireless communication between one or more of the processing units, one or more of the controllers, one or more of the sensors, and/or one or more of the relays; and one or more housing for hosting all or a portion of one or more of the sensors, one or more of the controllers, and/or one or more of the processing units.

Such systems can be configured such that one or more of the controllers is capable of controlling, monitoring, and/or sensing a theoretically unlimited number of circuits, provided adequate physical space for installation.

In embodiments, one or more of the sources of electrical power can be an energy storage system (ESS), a battery, a rechargeable battery, a power grid, a power plant, a generator, a photovoltaic energy source, and/or an inverter and/or a photovoltaic inverter.

One or more of the electrical loads can be an appliance, such as a household appliance such as a refrigerator, hot water heater, lighting, computers, audio/visual equipment, electric vehicle charging outlets/stations, etc.

In embodiments, one or more of the processing units and/or one or more of the controllers can be in operable communication with computer-executable instructions for apportioning a fixed power (Watt) or consumption (Watt-hour) cap to one or more or each of the appliances.

Systems, devices and methods of the invention can comprise, use, and/or execute computer-executable instructions capable of ingesting historical data to train machine learning models, specifically models designed to estimate predicted energy consumption and/or models designed to predict near-term energy output from one or more energy generation sources, including solar PV.

Systems, devices and methods of the invention can comprise, use, and/or execute computer-executable instructions for displaying a dynamic list of available circuits to users, accepting user responses and updating the list in response. In embodiments, the list can be contingent on available energy and power, and can involve and/or incorporate prioritization.

Systems, devices and methods of the invention can comprise, use, and/or execute computer-executable instructions capable of scheduling the amount of and/or distribution of electrical power to one or more of the circuits based on any one or more of anticipated use, available power, user preferences, and/or ESS charge.

Methods included within the scope of the invention include methods of demand-side management of off-grid energy consumption comprising: monitoring electricity consumption with one or more electrical current and/or voltage sensors in direct connection with one or more or each of multiple electrical circuits; selecting which of the multiple electrical circuits to energize or not to energize by activating one or more mechanical relay in direct connection with one or more or each of the multiple electrical circuits; and selectively controlling which of the multiple electrical circuits to energize or not to energize with a simulated protected loads panel (SPLP).

The SPLP can be configured to do all or one or more of the following:
allow a user to respond dynamically to changing circumstances, differing grid-outage scenarios, and/or fluid temporal preferences;
provide for a choice in which of the multiple electrical circuits to energize or not energize, without an electrical sub-panel;
provide for a choice in which of the multiple electrical circuits, while maintaining functionality of all of the multiple electrical circuits;
provide for identifying which circuits to prioritize and/or energize;
provide for identifying which circuits to prioritize and/or energize, according to an amount of available energy, anticipated PV (photovoltaic) output or other anticipated on-site energy generation, and/or expected consumption;
allow for optimizing household consumption allowances based on available ESS charge and data-driven predictions of PV or other on-site energy generation output and baseline household consumption needs.

In system, device and method embodiments of the invention, electricity consumption can be measured and/or controlled by way of sensors and relays that are inserted directly into each line exiting the main service panel.

The SPLP in embodiments is operably connected to a solar PV and ESS. Also included within the scope of the invention is an interactive user portal with API integration to the ESS, ESS charge controller and/or inverter or PV inverter, and the ability to ingest, store, and enact user preferences tied to specific outage events.

In addition, the software component of the SPLP has the capability of predicting near-term on-site energy generation output, including from solar PV arrays.

In aspects of the invention, residential neighborhoods can be provided where one or more, multiple, or each house in the neighborhood is equipped with DGPV (distributed-generation photovoltaic) and energy storage, creating in aggregate a virtual power plant, fully converting DGPV from a variable resource into a dispatchable resource that provides resiliency and energy to the grid.

### BRIEF DESCRIPTION OF THE DRAWINGS

The accompanying drawings illustrate certain aspects of some of the embodiments of the present invention, and should not be used to limit or define the invention. Together with the written description the drawings serve to explain certain principles of the invention.

FIG. 1 is a schematic diagram of a depiction of one possible embodiment of the device as attached to and covering the existing circuit breaker panel.

FIG. 2 is a schematic diagram of a depiction of one possible embodiment of the device with the circuit breaker panel cover removed and the internal aspects of the device and panel shown.

FIG. 3 is a schematic diagram of a depiction of one possible embodiment of the device with the cover and the frame removed and the internal aspects of the device shown.

FIG. 4 is a schematic diagram of a close-up depiction of one possible embodiment of the node and internal wiring of the device connected to circuits on the existing circuit breaker panel.

FIG. 5 is a schematic diagram of a depiction of the cover, frame, and internal components of one possible embodiment of the device, separated from one another.

FIG. 6 is a schematic diagram of a close-up depiction of one possible embodiment of the node.

FIG. 7 is a schematic diagram of a depiction of one possible embodiment of a group of nodes on a circuit board.

FIG. 8 is a schematic diagram of a depiction of one possible embodiment of the device with the internal aspects of the device shown, including groups of nodes on circuit boards placed in the overall device.

FIG. 9 is a schematic diagram of a depiction of one possible embodiment of the device with the internal aspects of the device shown, including groups of nodes on circuit boards placed in the overall device.

FIG. 10 is a schematic diagram of a depiction of one possible embodiment of a group of nodes configured together.

FIG. 11 is a schematic diagram of a close-up depiction of one possible embodiment of the node.

FIG. 12 is a schematic diagram of a close-up depiction of one possible embodiment of the node showing internal components.

FIG. 13 is a schematic diagram of a close-up depiction of one possible embodiment of the node showing internal components.

FIG. 14 is a schematic diagram of another possible embodiment of the device connected to an existing circuit breaker panel.

FIG. 15 is a schematic diagram showing a possible connection of an embodiment of the device as connected to an existing circuit breaker panel, with a close-up on the connections to the circuit breaker.

FIG. 16 is a schematic diagram of another possible embodiment of the device as connected to an existing circuit breaker panel.

FIG. 17 is a schematic diagram of a depiction of one possible embodiment of a group of nodes configured together.

FIG. 18 is a schematic diagram of a depiction of one possible embodiment of a group of nodes configured together as connected to an existing circuit breaker panel.

FIG. 19 is a schematic diagram of a depiction of one possible embodiment of a group of nodes configured together.

FIG. 20 is schematic diagrams of other possible embodiments of the device as connected to an existing circuit breaker panel.

FIG. 21 is a schematic diagram of a possible embodiment of the device showing internal components, as connected to an existing circuit breaker panel.

FIG. 22 is a schematic diagram of a possible embodiment of the device as designed for placement in a base frame with a lid.

FIG. 23 is a schematic diagram of a possible embodiment of the device as designed for placement in a base frame with a lid.

FIG. 24 is a schematic diagram of a possible embodiment of the device with groups of nodes hosted on a single circuit board.

FIG. 25 is a schematic diagram of a possible embodiment of the device showing a connection unit, base, or bar for facilitated connection to a circuit breaker panel.

### DETAILED DESCRIPTION

Simulated protected loads panels (SPLPs) according to the invention are expected to ensure continued growth of energy storage technology and DGPV by improving the economics of energy storage systems. The SPLP energy management system can be installed to control, monitor, and/or measure one or more components of a consumer's off-grid energy consumption of power provided by an ESS, such as by way of one or more electrical circuits, outlets, and/or loads. SPLP systems and methods according to the invention comprise and/or use hardware, embedded software, and cloud software. The SPLP may comprise hardware and software disposed in operable communication directly or indirectly with one or more components of the system. Hardware can be connected to the internet by way of a wireless network, wired connection, other means, or combinations thereof.

The hardware component is configured such that one or more selected circuits, or every circuit, can be controlled for example by the SPLP. The embedded software of the SPLP is responsible for interpreting measurements captured by the electrical current and/or voltage sensors, transmitting them successfully to the cloud software, and for receiving and properly interpreting signals sent from the cloud software. Embedded software is also used for establishing local API connections. The hardware and software are operably connected with solar PV and/or RES. The cloud-based software comprises machine learning models, multi-objective optimization algorithms, and predictive analytics and is the main driver of functionality and logic within the technology.

The simulated protected loads panel (SPLP) can provide value to homeowners in three main ways: (i) by providing flexible availability of all circuits during off-grid operation, (ii) by helping the homeowner appropriately size their ESS and/or PV array or other on-site generation source, and (iii) by allowing the homeowner to extract more flexibility out of existing ESS systems and PV arrays, simulating the effect of larger ESS systems through the addition of a SPLP. In aspects, the hardware component of the system can be configured to control and measure electricity flowing to all circuits in a home.

U.S. Pat. No. 10,109,987, which is incorporated by reference herein in its entirety, describes various embodiments of hardware designs. SPLPs according to embodiments of the invention can be configured to build on or enhance and/or incorporate all or some of the functionality of the LSP (Lumin Smart Panel) designs. Table I below highlights several features of the SPLPs:

TABLE I
SPLP FEATURES

Connection among hardware, software, EES charge controller,
PV inverter.
Software capable of apportioning a fixed Wattage cap to each
appliance and capable of continuing to ingest new historical
data to train machine learning models.
Software and hardware capable of determining which circuits to
energize and which to de-energize based on user preference,
EES charge, and available power.
Software capable of displaying a dynamic list of available
circuits to users, accepting user responses and updating the
list accordingly. The list can be contingent on available energy
and power, and can involve prioritization.
Software and hardware capable of determining optimal circuit
state in accordance with anticipated use, available power, user
preferences, and remaining EES charge.

Systems, devices and methods of embodiments of the invention can be configured to include physical and virtual integration with system components, including a PV inverter, charge controller, ESS, SPLP, and load-side demand.

In embodiments, the SPLP is configured to measure and control up to about 42 circuits or more, thus, associated hardware can be configured with one or more enclosure(s) capable of hosting/housing up to 42 circuits or more. Additionally, the housing(s) can be configured to be small enough to fit beneath or in close proximity to an existing main electrical service panel or panels and can be configured to comply with NEMA (National Electrical Manufacturers Association) outdoor installation certification. The enclosure(s) in embodiments is (are) preferably waterproof and airtight and is (are) sufficient to achieve NEMA certification for outdoor use. The internal electronics (including printed circuit boards, local computer, and power source) are packaged efficiently, to minimize the size of the hardware.

The SPLP hardware can comprise all or one or more of the following:
An energy management device installed at a consumer's premises. Such a device may incorporate physical hardware and software necessary for execution of its functions, or as practiced in the industry. In one aspect, such a device may incorporate an ability to obtain measurements of energy consumption on a circuit or groups of circuits in a circuit breaker panel, individual device, appliance, outlet or groups of devices, appliances, and/or outlets at a consumer's premises. In another aspect, such a device may incorporate the ability to turn on and off energy on specific circuits or groups of circuits as well as individual devices, appliances, outlets or groups of devices, appliances, and/or outlets at a consumer's premises.
Any additional energy management devices capable of two-way communication and energy consumption control. Such devices may include, but are not limited to, individual devices and appliances with built-in energy management capabilities such as thermostats, water heaters, and other devices. In addition, such energy management devices may include specific devices designed to control energy consumption of an individual or multiple circuits, loads, outlets or appliances.
One or more device(s) (such as a phone, tablet, computer or any other computing or communication means) used by a consumer to update specific settings, and/or perform other operations.
A computer server running software that enables the platform operations. Such a server may be set up as a separate physical machine or group of machines connected by means of a wireless network, wireless connection, or wired connection, through internet or some other wireless or wired communication(s). Alternatively, such a server may be set up as a virtual machine or group of machines operating in the “cloud” or a combination of physical and virtual machines. The computer server can be a computer, laptop or any other computing means. Such a server may be set up to input information from one or more sensor, such as a electrical current and/or voltage sensor, perform specific calculations using an appropriate algorithm, such as necessary load reduction, circuits to energize during a grid outage, and other parameters.

In embodiments, SPLP hardware associated with the invention (also referred to herein, e.g., as the device, apparatus, or system) can comprise a base frame, enclosure(s), or other containing unit that electrically, mechanically, and/or structurally attaches to an existing circuit breaker panel, parts of such panel, wall, wall studs or floor in proximity of an existing circuit breaker panel and serves as an attachment base or containing unit for components. In another embodiment, the apparatus comprises a mounting base or containing unit within which certain parts are included and which is electrically, mechanically, and/or structurally coupled, associated with, combined with, linked, paired, fastened, joined, attached, and/or connected to a circuit breaker panel, circuit breakers, parts of such panel, wall, wall studs or floor in proximity of an existing circuit breaker panel. The containing unit includes, but is not limited to, a box, on open-sided box, enclosure, protective structure, ornamental structure, or anything else that is able to hold, contain, or have components affixed to it.

The hardware/apparatus, in one aspect, comprises:
A containing unit, base frame, or mounting base;
Electric sockets, terminals, and/or lugs designed to pass high-voltage electricity from existing circuit breakers to existing circuits/loads, wherein the sockets are paired to accommodate high-voltage input and output lines located in such a manner to allow for measurement and/or control of high voltage electricity by below-mentioned relay(s) and sensor(s);
High voltage electric lines running from electric sockets, terminals, and/or lugs designed to pass high-voltage electricity from existing circuit breakers to existing circuits/loads, wherein the sockets are paired to accommodate high-voltage input and output lines located in such a manner to allow for measurement and/or control of high voltage electricity by sensor(s) and relay(s), in one embodiment, to connection rails, node(s), grouping(s) of nodes, circuit board(s), and/or containing unit, wherein the lines are paired to accommodate high-voltage input and output electricity flow;
Any one or more of the following, which can optionally be comprised by or within nodes or grouping(s) of nodes, which for example can be replaceable node(s), designed for particular electric current:
   current sensor(s) designed to measure electric current by circuit or group(s) of circuits and/or a voltage sensor(s) designed to measure electric voltage by circuit or group(s) of circuits and/or electrical current and/or voltage sensor(s), wherein in cooperation with the SPLP, the sensors and the system are capable of measuring voltage and current to within about 1% accuracy, in embodiments;
   electric relay(s) designed to switch on and off electric power by circuit or group(s) of circuits, wherein in embodiments the system is configured to have a relay response of about less than 1 second;
   computer chip(s) serving to receive, convert, process, store, and/or send signals to/from aforementioned current senor(s) and voltage sensors(s);
   computer chip(s) serving to receive, convert, process, store, and/or send signals to/from the relay(s) and/or serving to receive, convert, process, store, and/or send information, signals, algorithms, and/or computer code to/from other parts of the hardware/software apparatus such as other nodes, grouping(s) of nodes, other chip(s), other controller(s), or processing units as well as other devices, computers, and/or servers by means of wired or wireless connection;
   electric sockets, prongs, terminals, and/or lugs;
   port(s), pin(s) and/or other means for wire connection for the purposes of initial setup and/or troubleshooting of components of the hardware or node;
   LED light(s);
   one or multiple physical buttons for the purposes of initial setup and/or troubleshooting of components of the hardware or the node;
   circuit board(s) for hosting components of the hardware or node;
   enclosure(s) for housing components of the hardware or node;
   connector(s) for attachment to a connection rail, base frame, containing unit, mounting base, a circuit board, a back plane, or other nodes (although nodes do not have to be coupled to a containing unit; they may be stand alone or connected to or associated with a circuit board); and/or
   sockets or prongs to connect hardware components, such as a node, to for example, a back plane;
A back plane that has sockets and/or prongs for attachment of hardware components or nodes, wherein each socket and/or prong is isolated from other sockets and/or prongs so that high-voltage electricity remains within the designed circuit, and each socket and/or prong has low-voltage connection lines going to the processing unit;
A processing unit for receiving, processing, storing, and/or sending signals from and/or to the hardware components, nodes, and/or backplane, comprising:
   computer chip(s) that run the software operating the device;
   computer chip(s) designed to send and/or receive low-voltage signals to and/or from the hardware components or nodes;
   a wireless communication module(s) enabling connection to external devices and/or internet connection;
   port(s) for wire connection, such as for purposes of initial setup and/or troubleshooting of the processing unit and/or ongoing communication;
   a power connector, adapter, and/or module designed to receive electrical power to run the processing unit, hardware, and/or nodes;
   voltage sensor(s) designed to measure electric voltage;
   connector(s) designed to attach to the connection rails, back plane or elsewhere;
   connector(s) designed to power LEDs;
   a circuit board, printed circuit board (PCB), or multiple circuit boards or PCBs for hosting, holding, connecting, aggregating, containing, attaching, affixing, placing in, on, or near, resting, sitting, enclosing, including, surrounding, retaining, confining, joining, relaying, relating, uniting, linking, tying, and/or associating the hardware and/or nodes, or parts thereof,
   one or multiple physical buttons, such as for the purpose of initial setup and/or troubleshooting of the processing unit;
   an enclosure for hosting, holding, connecting, aggregating, containing, attaching, affixing, placing in, on, or near, resting, sitting, enclosing, including, surrounding, retaining, confining, joining, relaying, relating, uniting, linking, tying, and/or associating the processing unit and/or parts thereof,
A power supply line in the form of, for example, a circuit breaker connected to the existing circuit breaker panel, wherein the power lines run from the aforementioned processing unit to the aforementioned circuit breaker;
A battery to provide power to the hardware, nodes(s), processing unit, or parts thereof, especially during grid down times;
An optional cover frame that attaches to the base frame, containing unit, or mounting base, whereby the cover frame is designed to cover parts of the device. In one aspect, the cover frame is designed in such a way that the circuit breaker panel cover is attached to the cover frame. Moreover, the cover frame, containing unit, or mounting base, in one embodiment, has built-in illumination, such as LED illumination, and connectors to receive power from the processing unit, one or multiple physical buttons for the purposes of initial setup, troubleshooting of the processing unit, or other purpose, and, in one aspect, a port for wire connection(s) for the purposes of initial setup, troubleshooting of the processing unit, or other purpose; and/or
An optional source of sound such as a dynamic speaker or beeper that may be coupled with the processing unit or cover frame. In one aspect, the source of sound may be used for sending signals to the user and/or technician to indicate a current state of the device, respond to certain actions taken by the user (for example, pressing buttons), or troubleshooting.

A back plane, or connection rail, is, in embodiments, a circuit board(s) or PCB(s), including multiple sockets and/or prongs for receiving, for example, nodes, sensor boards, circuit boards, or groupings of nodes, as explained herein.

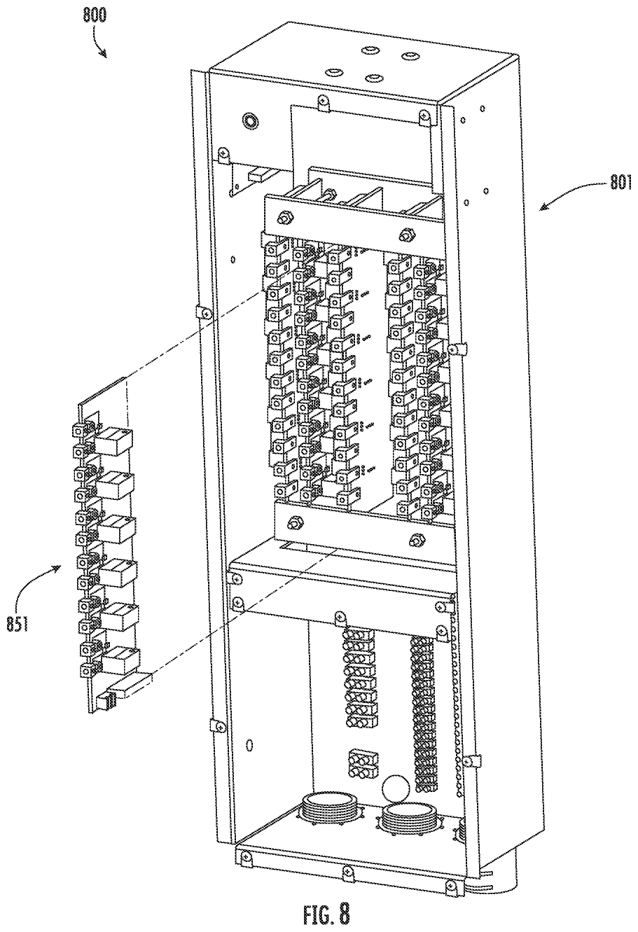

In a preferred embodiment, the invention is a stand-alone product that is coupled or connected to an existing or soon-to-be-installed circuit breaker panel. Specifically, the invention is a device that extends the capabilities of an installed circuit breaker box by adding monitoring and controlling features to individual circuits, by way of, for example, one or more electrical current and/or voltage sensor(s) and relay(s). In one embodiment, the device is shaped as a frame that is attached externally to an existing circuit breaker box. In another embodiment, the device is a box or mounting base to which the parts of the apparatus can be installed, contained, coupled, or attached (e.g., see FIGS. 8-10, 15-25). Once the device is connected to an existing circuit breaker box, one or more circuits in the box can be wired to connect to the device.

In one embodiment, an apparatus comprises one or more containing units, which may be boxes, frames, panels, bases, or any other structure which may house components or be affixed to components. The parts of the apparatus may be contained in one unit, such as a metal or plastic box. In other aspects, the parts may be placed in more than one unit; such as multiple metal or plastic boxes. In another aspect, the parts may be in or on an existing circuit breaker panel. The parts of the apparatus may comprise:
electrical connection(s) to a circuit breaker(s);
a relay or relays;
a current and/or voltage sensor or sensors;
electrical connection(s) leading to and/or from an electrical load(s), for example, on a premises;
controlling unit or units connected to hardware, one or more nodes, and/or parts thereof, wherein the controlling unit or controller is generally a computer chip that runs a pre-defined software code, pre-created set of codes, or algorithms and uses communication protocols, such as (but not limited to) CAN bus, Modbus, Ethernet, USB, SPI, or I2C to send data to the processor to perform operations on data provided by sensors;
processing unit or units connected to one or more nodes or controlling units, the processing unit(s) comprising a computer chip(s) that runs the software operating the device, a computer chip(s) designed to send and/or receive low-voltage signals to and/or from the aforementioned nodes, and/or a wireless communication module(s) enabling connection to external devices and/or internet connection.

A node may comprise a current sensor(s) designed to measure electric current by one or more circuits, a voltage sensor(s) designed to measure electric voltage by one or more circuits, and an electric relay designed in part to switch on or off electric power from the one or more circuits.

In one example, the installation process comprises:
mounting one or more sensors and/or relays to wires connecting one or more circuit breakers inside a new or existing circuit breaker box with an electrical load associated with, on and/or in the premises;
associating wires or otherwise connecting electrical input sockets, terminals, and/or lugs on the device or SPLP and existing circuit breakers allowing for one connection per one input socket, terminal, and/or lug of a single node in the device with a single circuit breaker.

In another example, the installation process comprises:
unmounting wires connecting one or more circuit breaker(s) inside a new or existing circuit breaker box with an electrical load associated with, on or in the premises;
mounting said wires into output electrical sockets, terminals, and/or lugs on the device allowing for connection of one load wire per one output socket, terminal, and/or lug of a single node in the device;
mounting one or more sensors and/or relays to the wires;
mounting wires or otherwise connecting electrical input sockets, terminals, and/or lugs on the device and existing circuit breakers allowing for one connection per one input socket, terminal, and/or lug of a single node in the device with a single circuit breaker.

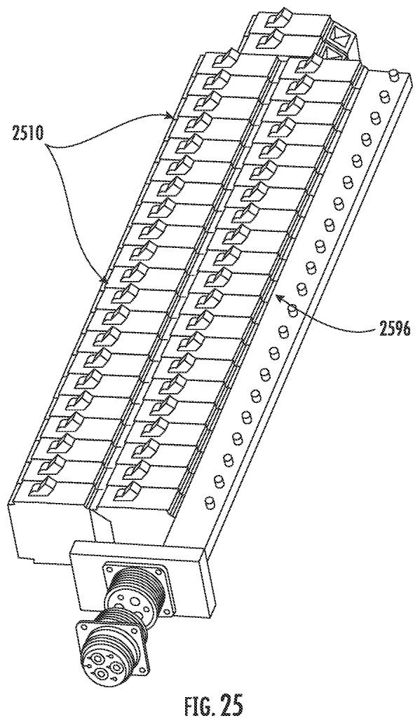

In another embodiment, the device may be or include a high-voltage connector bar (see, e.g., FIG. 25) comprising a base, such as a board or a back plane, one or more connectors to attach nodes to circuit breakers in a circuit breaker panel, and one or more connectors to attach nodes to the apparatus, controlling units, processing units, or electrical loads, for example, on a premises. Such a high-voltage connector bar may be used to streamline the installation process and wiring of high-voltage wires conducting electricity from circuit breaker(s) to the device and/or the device to load(s) and/or appliances.

In certain embodiments, structural features making the device different from existing solutions include, among other features described herein, the position of energy monitoring sensors, relays, and processing unit that may be external to or separate from the existing circuit breaker box or existing circuits breakers. Also, the frame or frames, or mounting base or bases, or containing unit or units, are attached to an existing circuit breaker box, in a preferred embodiment, externally so as to retrofit the existing circuit breaker panel. In colloquial terms, the invention described herein transforms an existing circuit breaker panel into an interactive, “smart” circuit breaker panel.

Beneficial features of the present invention to the user include, among other things described herein: the ability to provide for a full or partial energy management system for a premises sustained by an RES system with detailed consumption breakdown and control, and the ability to obtain such energy management system for a premises without the need to perform costly and lengthy circuit breaker panel replacement/installation.

The present invention adds energy management capabilities when attached to a new or existing circuit breaker box. While the core purpose of a circuit breaker box is to distribute electricity from the main feed to multiple circuits, the invention brings new features to such a circuit breaker panel, such as the ability to monitor and control electricity consumption, including remotely, especially to monitor and control electricity provided to various appliances and loads from an off-grid type ESS.

The system can allow remote control of the processor(s), controller(s), hardware, and/or node(s) so that the outlet(s) and/or load(s) being controlled can be remotely turned on or off, or otherwise regulated. The hardware, nodes or processor(s) may communicate with one or more remote devices, including but not limited to a phone, computer, laptop, tablet, or other communication or computing device, such as in one embodiment through the internet, and in another embodiment through cell phone signals, Bluetooth®, Ethernet, or Wi-Fi, to transmit information regarding energy consumption and providing the user with the option to turn on or off the outlet(s) and/or load(s) or otherwise control the power consumption at the downstream outlet(s) and/or load(s), at the circuit breaker(s), or at the circuit breaker panel(s).

Software of the SPLP system can be configured to ensure that data is collected, aggregated and processed accurately and timely. The software can include an integration loop capable of switching circuits on and off sufficiently fast to avoid brownouts according to software inputs and logic. The software can also be configured to include logic that can communicate to a user which circuits are available for use, according to rapidly changing circumstances including current consumption, predicted PV output, current ESS charge, and anticipated consumption (which is a factor of time of day, temperature, and can be determined largely through machine learning models).

Software, embedded or in the cloud, is responsible for aggregating and interpreting measurements, transmitting data to the cloud, receiving and processing control signals, and forms the basis of local and off-line communication. These capabilities combine to allow the SPLP to bridge the cyber-physical gap, allowing cloud-based software to control circuits physically in near-real time. This capability is core to the SPLP functionality of allowing users to decide flexibly which circuits to energize during a grid outage, and will contribute to improving the net present value (NPV) of RES, which has strong positive downstream effects on ESS and distributed generation renewable energy economics. The internal electronics include, for example, printed circuit boards capable of interacting with relays (which may be mechanical relays), sensors (which may be hall effect sensors), and an onboard computer. Firmware is also included, ensuring proper interpretation, transmission and reception of data.

The software can comprise any one or more of the following elements:
software code (computer-executable instructions) installed on and/or operating on a user's computer or other device at a user's/consumer's premises;
software code installed on and/or operating on a user's device such as a phone, tablet, computer or any other device used for monitoring and/or control purposes (e.g., an app and/or webpage);
software code installed on and/or operating on a remote server or “cloud” (e.g., software on the “cloud”); and/or
software code installed and/or operating on servers and/or computers belonging to a third party.

Embodiments of the invention also include a computer readable medium comprising one or more computer files comprising a set of computer-executable instructions for performing one or more of the calculations, steps, processes and operations described and/or depicted herein. In exemplary embodiments, the files may be stored contiguously or non-contiguously on the computer-readable medium. Embodiments may include a computer program product comprising the computer files, either in the form of the computer-readable medium comprising the computer files and, optionally, made available to a consumer through packaging, or alternatively made available to a consumer through electronic distribution. As used in the context of this specification, a “computer-readable medium” is a non-transitory computer-readable medium and includes any kind of computer memory such as floppy disks, conventional hard disks, CD-ROM, Flash ROM, non-volatile ROM, electrically erasable programmable read-only memory (EEPROM), and RAM. In exemplary embodiments, the computer readable medium has a set of instructions, such as software code, stored thereon which, when executed by a processor, cause the processor to perform tasks, based on data stored in the electronic database or memory described herein. The processor may implement this process through any of the procedures discussed in this disclosure or through any equivalent procedure.

In embodiments of the invention, files comprising the set of computer-executable instructions may be stored in computer-readable memory on a single computer or distributed across multiple computers. A skilled artisan will further appreciate, in light of this disclosure, how the invention can be implemented, in addition to software, using hardware or firmware. As such, as used herein, the operations of the invention can be implemented in a system comprising a combination of software, hardware, or firmware.

Embodiments of this disclosure include one or more computers or devices loaded with a set of the computer-executable instructions described herein. The computers or devices may be a general purpose computer, a special-purpose computer, or other programmable data processing apparatus to produce a particular machine, such that the one or more computers or devices are instructed and configured to carry out the calculations, processes, steps, operations, algorithms, statistical methods, formulas, or computational routines of this disclosure. The computer or device performing the specified calculations, processes, steps, operations, algorithms, statistical methods, formulas, or computational routines of this disclosure may comprise at least one processing element such as a central processing unit (i.e. processor) and a form of computer-readable memory which may include random-access memory (RAM) or read-only memory (ROM). The computer-executable instructions can be embedded in computer hardware or stored in the computer-readable memory such that the computer or device may be directed to perform one or more of the calculations, steps, processes and operations depicted and/or described herein.

Embodiments of this disclosure comprise a computer system for carrying out the computer-implemented method of this disclosure. The computer system may comprise a processor for executing the computer-executable instructions, one or more electronic databases containing the data or information described herein, an input/output interface or user interface, and a set of instructions (e.g. software) for carrying out the method. The computer system can include a stand-alone computer, such as a desktop computer, a portable computer, such as a tablet, laptop, PDA, or smartphone, or a set of computers connected through a network including a client-server configuration and one or more database servers. The network may use any suitable network protocol, including IP, UDP, or ICMP, and may be any suitable wired or wireless network including any local area network, wide area network, internet network, telecommunications network, Wi-Fi enabled network, or Bluetooth® enabled network. In one embodiment, the computer system comprises a central computer connected to the internet that has the computer-executable instructions stored in memory that is operably connected to an internal electronic database. The central computer may perform the computer-implemented method based on input and commands received from remote computers through the internet. The central computer may effectively serve as a server and the remote computers may serve as client computers such that the server-client relationship is established, and the client computers issue queries or receive output from the server over a network. The computer system can be configured to operate by way of the cloud.

The input/output interfaces may include a graphical user interface (GUI) which may be used in conjunction with the computer-executable code and electronic databases. The graphical user interface may allow a user to perform these tasks through the use of text fields, check boxes, pull-downs, command buttons, and the like. A skilled artisan will appreciate how such graphical features may be implemented for performing the tasks of this disclosure. The user interface may optionally be accessible through a computer, mobile phone, and/or tablet device connected to the internet, local network (intranet), or cellular network. In one embodiment, the user interface is accessible by typing in an internet address through an industry standard web browser and logging into a web page. The user interface may then be operated through a remote computer (client computer) accessing the web page and transmitting queries or receiving output from a server through a network connection. In another embodiment, the user interface is accessible by opening a mobile application on a mobile phone and/or tablet device while connected to the internet, local network (intranet), or cellular network.

In embodiments, the invention includes an Integrated Circuit or integrated circuit chip (“IC”), which, in aspects, is or includes a set of electronic components or circuits (including but not limited to resistors, capacitors, transistors, or diodes, by way of example) designed to perform an electrical function or set of functions, built upon layers of semiconductor material (such as silicon for example) that can be interconnected or assembled within a packaging material (such as, by way of example, plastic, ceramic, and/or metal) that can include pins or pads to connect to external components or circuits. An IC may also be referred to as or include, by way of example, a microelectronic circuit, a microchip, a computer chip, or a chip. Examples include, but are not limited to, a microprocessor, a computer processor, a central processing unit (CPU), a microcontroller (uC), a microcontroller unit (MCU), a system on a chip/system-on-chip (SoC), field programmable gate array (FPGA), complex programmable logic device (CPLD), or combinations thereof.

The device/system can monitor energy consumption by, for example, by measuring electrical current passing through one or more electrical circuits. For example, electrical consumption can be measured by way of information received from one or more electrical current and/or voltage sensor disposed and/or otherwise in operable connection/communication with one or more electrical circuit. In embodiments, the sensor(s) can be disposed in a manner such that measurements are taken on an electrical line exiting the electrical service panel. Software is used in cooperation with the sensor(s) to determine/measure electrical voltage (or other unit, such as wattage or current). Information collected from the sensor(s) and received by the software can be saved in memory of the device and/or transmitted to an online server or in the cloud through an internet connection, or otherwise communicated wirelessly or with a wired connection to a user or some other device, such as a phone, smartphone, tablet, computer, or electronic storage apparatus.

Data received from the sensor(s) can be classified and/or analyzed by an algorithm determining consumption. Data can be stored in memory for future analysis of consumption trends, such as over certain periods of time, or stored elsewhere, such as on or in the cloud. In one aspect, data is also aggregated to provide a combined view over total power consumption of the building/premises as well as consumption of certain circuit(s) and/or circuit groups, consumption of certain device types, consumption of certain loads, consumption of certain outlets, consumption of certain appliances, consumption of certain rooms, and so on.

Stored data may then be copied, stored, and/or shared through connection to the internet, or otherwise copied, stored, and/or shared by some other means, such as by way of a wired connection or other type of wireless connectivity.

The software can be configured to perform calculations for near-real-time consumption to provide users with real-time consumption values. The near-real-time consumption values will reflect the amount of energy needed to operate a whole premises and/or specific circuit(s), load(s), appliance(s), outlet(s), etc. In one aspect, to calculate consumption values, the software takes current consumption in kilowatts and extrapolates it for a defined period(s) (hour, minute, or second) as if such consumption remains at a steady level for such a period(s), adjusted for known, observed or predicted temporal trends. As a result or output of the software, the user/consumer may receive information on total expected or actual consumption on a whole-house basis or on a load-, appliance-, outlet-type basis.

Based on sensor measurements, predicted/expected electricity usage, predicted/expected availability of electrical power, and/or user/consumer preferences, the software can be configured to allow for an operating schedule such that certain circuit(s), load(s), appliance(s), outlet(s), etc. to turn on/off at specific and/or automated scheduled times. For example, during a power outage the user can switch over to and/or the system can automatically access the connected ESS to supply power to various electrical circuits of choice, such as a hot water heater, computers and/or a refrigerator, and the circuit/power available to such selected appliances/loads can further be scheduled to operate at certain times. For example, certain lighting may be selected to receive power from the ESS during an outage, but only at night. The appliances/loads can be prioritized such that if the ESS is only capable of supplying adequate power to some of the selected appliances/loads and not to others, appliances/loads with a higher priority can be automatically powered first. The selected times/priorities may be specifically assigned by a user, or they may be suggested or implemented by the software based on typical usage by the user and/or other electricity consumers. Further, for example, if an HVAC appliance is prioritized over lighting and the ESS only has enough power to provide electricity to the HVAC system, then the HVAC system will run but not the lights, or while the HVAC system is not running (e.g., blower is off), then the lower priority lights can operate when the HVAC blower is not running.

Algorithms, especially machine learning algorithms, of the invention can be used to present recommendations to the user regarding electricity consumption. For example, the software may perform analysis of a user's consumption trends and patterns and create certain recommendations and suggestions based on such an analysis. The frequency of the analysis may be predetermined with regular intervals such as day, week, month, quarter, year or any other interval, or the frequency may be determined by a user on a custom basis including an ability to launch such analysis upon request. Analysis of consumption trends can be designed to identify certain repeatable actions and events in a household's energy consumption, locate specific equipment units responsible for certain portions of energy consumption, and create detailed recommendations and proposals on prioritizing and/or scheduling appliances and loads. The outcomes of the analysis may include specific insights and personalized action recommendations for a user to determine various groups of appliances and loads that can be powered together during an outage. These action recommendations may address specific user behavior patterns that may include recommendations on usage of specific energy consuming equipment in specific areas of the house during specific time periods. An example of such recommendations may be an indication that a user typically keeps lights on in a specific room at a specific time and a suggestion to power these lights during that time even when during and outage. Such recommendations may be accompanied with a calculation of how much electricity the addressed equipment consumes over the course of a month, a year, or any other time period as well as calculation of the costs that might be incurred in association with use of the particular appliance/load.

In addition to behavioral recommendations, the software may include a suggestion to automate certain actions leading to improvements in energy consumption. Such automation may involve setting up certain schedules for turning on and off specific circuits and devices. The suggestion may describe a specific consumption pattern identified by the software and a description of a solution suggested to a user. For example, the software may suggest that it will automatically turn off the circuit feeding the lights in the bedroom from 10 am to 4 pm during workdays during an outage, but prioritize those lights to operate at night above other appliances, such as a washer/dryer.

The software may provide a user with an option to use a set of rules targeted at energy management. Such set of rules may be developed and updated manually by a user or created and updated with pre-programmed algorithms. Alternatively, a mix of the two approaches (manual and pre-programmed) may be used.

In one aspect, such rules may include a specific indication of:
An individual device or circuit, or group of devices or circuits, that fall under the respective rule;
Specific timing for turning on and off specific devices and/or circuits;

Identification of specific days or other periods when the rule is activated (for example, daily, hourly, or twice per hour in the period from 6 pm to 9 pm on weekends etc.); and/or
Other parameters.

A set of rules may consist of one or more rules activated simultaneously or during different time periods.

In one aspect, a user may create a set of rules by accessing a respective menu and setting up appropriate rules in a user interface of the software on the online server or in the app installed on a user's device(s) (phone, tablet, computer, etc.). Alternatively, the software may design, or have, a set of pre-programmed rules. In one aspect, setting such pre-programmed rules may include analysis of specific devices, circuits and/or groups of devices and circuits. The software may look for specific parameters identifying devices and/or circuits that may be turned on and off. For example, the software may be looking for a device and/or circuit with a name “Water heater” or “Boiler”. Once such device and/or circuit is identified, the software may create a rule that dictates turning off said device/circuit while user is absent.

The application programming interface (API) can provide for graphical controls and components that are reusable class files that are delivered with a programming language. For example, pull-down menus may be implemented in an object-oriented programming language wherein the menu and its options can be defined with program code. Further, some programming languages' integrated development environments (IDEs) provide for a menu designer, a graphical tool that allows programmers to develop their own menus and menu options. The menu designers provide a series of statements behind the scenes that a programmer could have created on their own. The menu options may then be associated with an event handler code that ties the option to specific functions. Text fields, check boxes, and command buttons may be implemented similarly through the use of code or graphical tools. A skilled artisan can appreciate that the design of such graphical controls and components is routine in the art.

In embodiments, the software can be provided as an application, or other software on a device or number of devices (such as a phone, tablet, computer or any other computing means), or by way of the cloud through a software as a service platform. In some embodiments, registration (pairing) of said user devices (such as a phone, tablet, computer or any other computing means) with the SPLP platform and/or software may be employed for example by assigning a unique identification number(s) or barcode or other identification information to each device or other means. Consumer/customer and other information may be encrypted or otherwise made to be confidential.

Once a consumer/customer is registered, the software may proceed to identify and record a list of circuits, devices, appliances, loads, and/or outlets existing in a customer's premises and/or such information may be input by the user/consumer. Such circuits, devices, loads, appliances, and/or outlets may be considered by the software as options for distributing available and/or projected amounts of electrical power. The software may analyze previous consumption history of the user and/or other users and assign identified loads (such as a circuit, device, appliance, or outlet) with a number of characteristics that may be used in determining whether a particular load or loads can participate in distribution of an available and/or projected amount of electrical power. Such characteristics may include one or more of the following:
Energy consumption parameters such as watts, volts, and amps;
Patterns describing load usage and energy consumption;
Frequency of load usage;
Typical time periods of consumption;
Typical days of consumption;
Seasonal effect on consumption;
Weather effects on consumption; and/or
Other parameters.

In another aspect, the software and/or users through input into the system may assign identified loads with indications of periods of activity and inactivity.

Before explaining aspects of the invention in detail, it is to be understood that the invention is not limited in its application to the details of construction and the arrangement of the components set forth in the following description or illustrated in the drawings. One of ordinary skill in the art would understand that the invention is capable of other embodiments or of being practiced or carried out in various ways. Also, it is to be understood that the phraseology and terminology employed herein is for the purpose of description and should not be regarded as limiting.

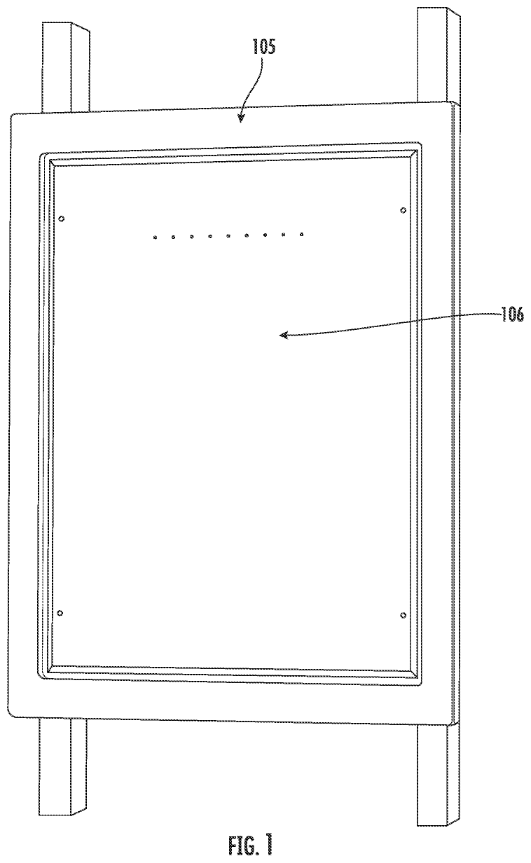

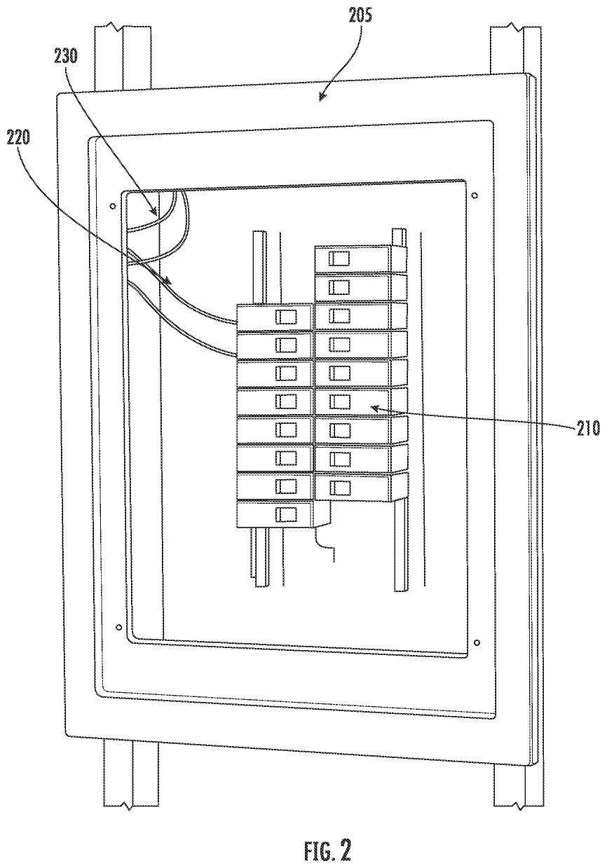

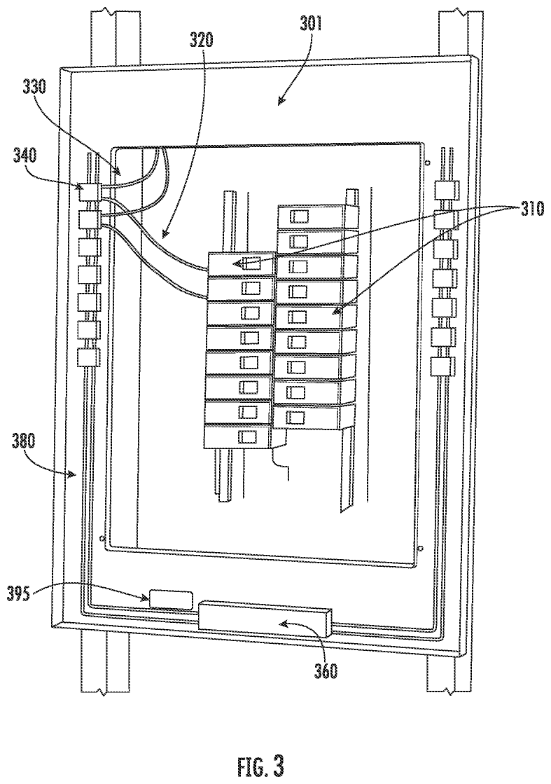

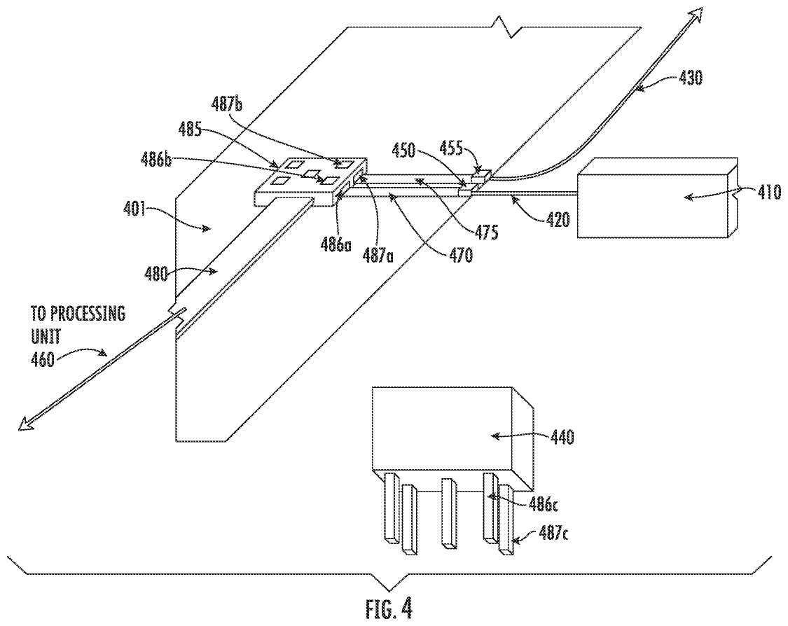

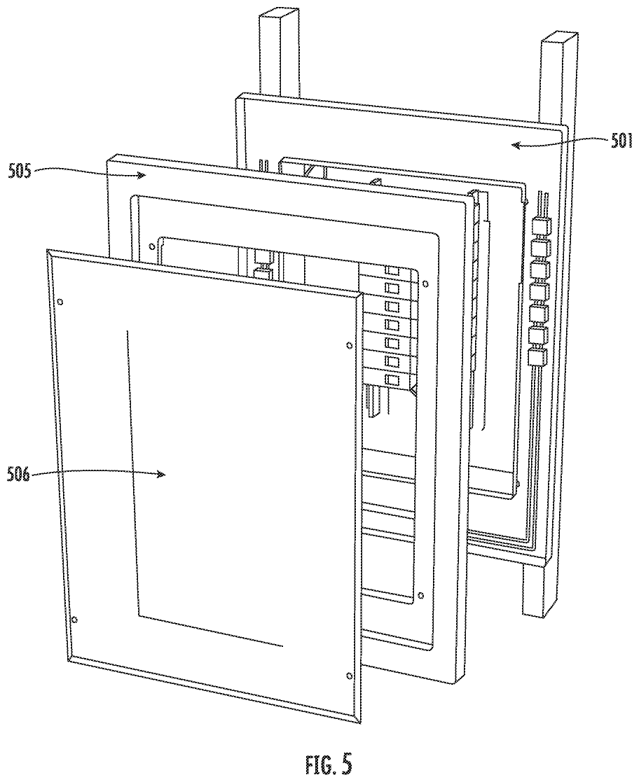

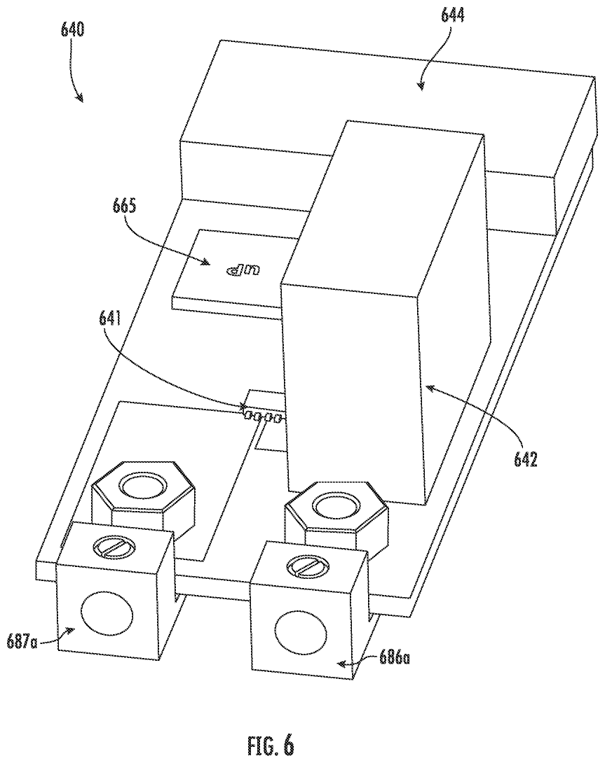

Now turning to particular figures, FIG. 3 is a pictorial diagram of an embodiment of the apparatus according to the present invention. (FIGS. 1, 2, and 5 show other perspectives of an embodiment of the device in less detail than what is shown in FIG. 3, but these figures give a broader perspective on possible embodiments of the apparatus as a whole.) The cover frame for the apparatus 105 in FIG. 1 (205 in FIG. 2; 505 in FIG. 5) and the front cover of existing circuit breaker panel 106 in FIG. 1 (506 in FIG. 5) are removed in FIG. 3, showing, for example, the nodes 340, a connection rail 380, the processor 360, a battery 395, and other components. The cover frame 105 in FIG. 1 (205 in FIG. 2; 505 in FIG. 5) as attached to the base frame 301 (see also 501) appears in FIGS. 1, 2. The nodes 340 of the apparatus are explained in more detail in FIG. 4 and FIG. 6 and generally in this application. They are electrically connected 320 (see also 220) to the existing circuit breaker panel's circuit breakers 310 (see also 210). These nodes communicate power consumption to the processor 360 through wires or other means 380. The processor then monitors and controls energy consumption by way of algorithms or user input as described herein. The algorithm or user input then provides feedback to the node 340 which controls downstream outlets, electrical loads, and/or hardwired devices, such as lights, home appliances, etc. through electrical connections 330 (see also 230).

The processor 360 also allows for communication with an electronic device such as a phone, computer, or tablet (e.g., Apple iPad). The electronic device may be external to, in addition to, remotely located, or otherwise considered outside of the configuration of the inventive apparatus. This may be accomplished by, in certain embodiments, a Bluetooth connection, wi-fi signal, or Internet connection. In an embodiment, the processor will send encrypted energy consumption related information to an outside device or group of devices. The user of the apparatus taught herein and outside device (e.g., an energy consumer, utility company customer, utility company, etc.) will be able to monitor and control energy consumption. In one embodiment, the processor sends for display on the outside device energy consumption on a circuit-by-circuit level or by load, outlet, appliance, etc. on the circuit(s). The user will have the option to turn off or otherwise modulate that circuit depending on what outlet, load, and/or appliance is served by that circuit, as described herein. For example, if a light in the bedroom of a premises with the apparatus claimed herein is left on and consuming energy, this will be communicated to the processor, which will then alert a user of a remote device (e.g., cell phone) and give the user the option to turn off the circuit, thereby stopping delivery of electricity to the lamp and therefore saving energy. A battery 395 could be located in or around the device or the device could be powered by some other means. A battery may be used if power to the circuit breaker panel is lost, or if LED lights or other indicators on the device may be implemented to notify a user of the device's location, or to indicate device and/or other status.

FIG. 4 is a pictorial diagram of an embodiment of the apparatus according to the present invention. In one aspect, a base frame 401 allows for mounting of the device onto an existing circuit breaker panel. In addition, the base frame 401 serves as a basis for attachment of other components of the device such as:
electric connectors, such as sockets, terminals, lugs, or plugs 450, 455,
high voltage electric lines 470, 475,
connection rail 480,
processor 460,
battery (395 in FIG. 3),
and cover frame (105 in FIGS. 1 and 205 in FIG. 2), which, in embodiments, is placed over base frame 401.

Electric sockets 450, 455 can serve as input and output points for electricity flowing from a circuit breaker 410 through the device to various electric loads in the premises. Once the device is installed, an input electric socket 450 can be connected by a wire or group of wires 420 with a single circuit breaker 410. An output electric socket 455 can be connected by a wire or group of wires 430 with an electric load. In one embodiment, the input/output sockets 450, 455 are paired in a manner allowing for a single input/output socket pair to be connected to a single node socket/pad 485 and node 440 by means of high voltage electric lines 470, 475.

In embodiments, high voltage electric lines 470, 475 connect input/output electric sockets 450, 455 and node pad 485 and the replaceable nodes 440 installed or otherwise connected to node pads 485. The lines 470, 475 conduct high voltage electricity (e.g., 120V). The lines 470, 475 are paired in a manner for a single input/output pair of lines to be connected to a single pair of side sockets 486a, 487a on the node pad 485, which may be part of or attached/connected to a connection rail 480.

In one embodiment, electrical input is passed from high voltage electric socket 486a to electric socket 486b, both of which are located on the node pad 485. Electrical output is passed from electrical socket 487b to electrical socket 487a, and then through high voltage line 475. That current flows through socket 455 to wire 430 and out to electric loads on for example a premises.

In one embodiment, an optionally replaceable electric node 440 serves to conduct electricity from electrical socket 486b to 487b. Such electrical flow is conducted through the node using pins 486c and 487c. For example, electric current passing through electric socket 486b connects to pin 486c, passes through, is measured by, and is modulated by the node as will be explained herein, and then passed back through pin 487c to electrical socket 487b.

Nodes 440 may come in a variety of grades based on the electric current they are designed to conduct. For example, a current supplied through a 15 amp circuit breaker is preferably served by a 15-20 amp grade node. In one aspect, specific grade of the node 440 for each node pad 485 on the connection rail 480 may be chosen at the time of installation based on the grade of the circuit breaker connected to input electric socket 450. A node 440 may, in one aspect, comprise a circuit board that hosts elements such as, for example, a current sensor, a voltage sensor, and a relay. In an embodiment, a node 440 has a plurality of connector pins. In one aspect, two pins 486c, 487c serve as input/output high voltage connectors receiving/sending electricity from/to sockets 486b, 487b located on the node pad 485. Other pins can serve to provide power to the circuit board and its elements as well as to transmit current sensor readings and receive on/off commands from processing unit 460. In one aspect, LED lights serve to indicate a node's status through various combinations of timing, intensity and colors of the lights. Button(s) may serve to test, reset, troubleshoot or otherwise interact with the node.

In one embodiment, a node 440 is encapsulated into an enclosure that covers and protects elements of the node. Such enclosure may have openings for connector pins (e.g., 486c, 487c, and others) and, in one aspect, LED lights and/or button(s). Once installed, a node 440 takes, in one example, constant, semi-constant, frequent, periodic, manual, programmed, singular, and/or regular measurements of electric flow on the connected circuit. The measurements are communicated to the processor 460 through, for example, the connection rail 480 using one or multiple communication protocols such as but not limited to CANBus, Ethernet, I2C, SPI or other protocols. Upon receipt of command signals from the processing unit 460, a node 440 turns on or off a relay controlling electricity flow, as described herein.

In an embodiment, the connection rail 480 serves as a base for node pads 485 designed for mounting of optionally replaceable nodes 440, which plug into the node pad 485, as well as a communication bridge between the node 440 and processing unit 460. In one aspect, the connection rail 480 is attached to the base frame 401. The connection rail 480 may have a plurality of node pads 485 for mounting replaceable nodes 440. In one aspect, each node pad 485 on the connection rail 480 has a number of connection ports or terminals (e.g., 486b, 487b) corresponding to the number and size of connector pins (e.g., 486c, 487c) on a replaceable node 440.

In one embodiment, two of such ports 486b, 487b are connected with respective input/output sockets 486a, 487a in the node pad 485 which is on a connection rail 480 and connected respectively to high voltage lines 470, 475. This connection is designed to conduct high voltage electricity and connect a node's input/output high voltage connector pins 486c, 487c to high voltage electric lines 470, 475. In one embodiment, port(s) of each node pad 485 serve to provide power to the circuit board in/on the node 440 and its elements as well as to transmit current sensor readings and receive on/off commands from processing unit 460. The ports other than the high-voltage ports can be designed to be low voltage and are placed and shaped to receive corresponding connector pins on a replaceable node 440. In one aspect, each node pad 485 on the rail 480 is isolated from other node pads so that high-voltage electricity remains within the designed circuit. In another embodiment, the node pads and corresponding nodes may link or connect by way of communication means (e.g., 480). The connection rail 480 may have a plurality of low voltage connection lines transmitting signals between nodes 440 and processing unit 460.

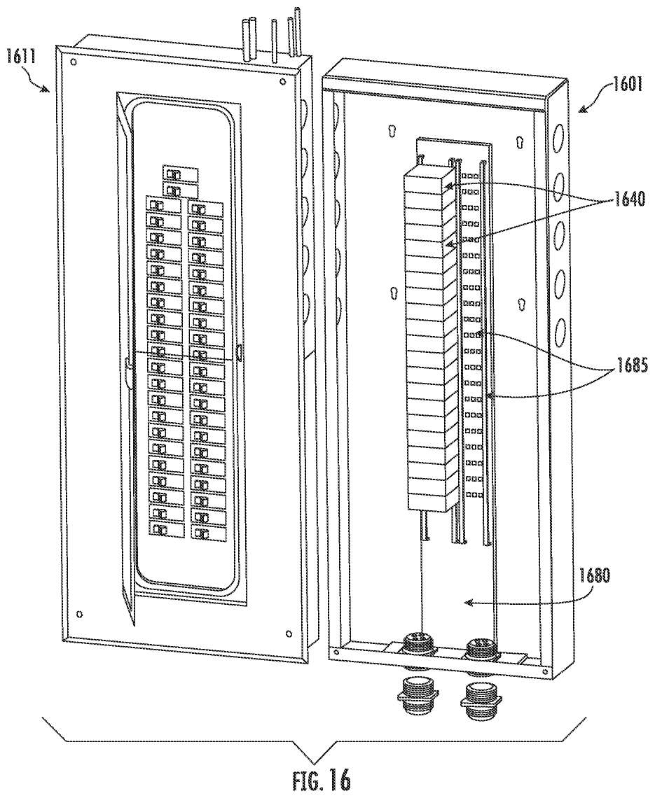

A processing unit 460, such as in an embodiment an integrated circuit chip (or “IC”) (e.g., “computer processing unit” or CPU), serves as a processing and/or communications center for the device. In an embodiment, the processing unit 460 is attached to the base frame 401, but it can be located separately from the existing circuit breaker panel (see, by ways of example only, FIGS. 16-25). The processing unit, in an embodiment, comprises a circuit board or multiple circuit boards that host elements including, by way of example, one or more of an IC, a processor chip(s), a controller chip(s), a voltage sensor(s), a wireless communication chip (or multiple chips), a port(s) for wired connection, a power connector(s) and/or power supply/converter(s), ports for mounting on connection rail(s), various connectors powering cover frame LED illumination, and/or physical buttons. Once installed, the processing unit 460 receives measurements of electric current and voltage taken by the nodes 440 as well as sends back signals to the nodes to open/close relays, among other things. Information on electric current and voltage received from the nodes 440 can be processed by software or algorithms running on the IC (e.g., processor chip(s)) or running remotely. In an aspect, the information may be communicated to a remote server over the Internet by means of wired or wireless connection. The processing unit 460 may have a plurality of low voltage ports for proper attachment of low-voltage connection lines embedded into the connection rail 480. In aspects, through these ports processing unit 460 receives and sends signals from/to nodes 440. The processing unit 460 may send signals to the nodes 440 that will result in opening or closing specific relays to turn on and off respective circuits. Such signals may be based on commands generated by the software on the processor, a controller, or a web-based server, or commands generated by a user via various input methods such as Internet website interface, mobile app interface, home energy monitor screen interface, physical buttons and others. The processing unit 460, in aspects, can also send various signals to control cover frame LED illumination to reflect various states of the device. Based on the state of the grid or other conditions, processing unit 460 may be powered either through the power line or by the battery (395 in FIG. 3), an outside battery, or some other outside power source. In some cases, whenever processing unit 460 is powered through the grid, it may charge a battery. The processing unit may be encapsulated into an enclosure that covers and protects all elements of the unit.

In embodiments, a power supply line serves as the main source for electric supply to the device. The power supply line can connect a circuit breaker(s) located in an existing circuit breaker box with a power adapter/converter installed in the device separately or as a part of the processing unit. In one embodiment, the device may receive power from one or more of the controlled circuit lines and/or existing circuit breaker(s).

In embodiments, a battery (395 in FIG. 3) may serve as an additional power source for the device during grid power outages. In one aspect, a battery is attached to the base frame 401 but it is envisioned that it can be connected to but located separately from the apparatus described herein. In another aspect, a battery is an integral part of the processing unit and is attached directly or indirectly to the processing unit or processing unit circuit board. A battery can be charged by electricity supplied through a power line. During grid down times, a battery may be able to power the device as a whole, or certain parts of it.

In an aspect, a cover frame (105 in FIG. 1) allows for casing of all elements of the device. A cover frame may be attached to the base frame 401. A cover frame may be designed in such a way that an existing cover of a circuit breaker panel (106 in FIG. 1) can be mounted over the cover frame, or act as the cover frame. A cover frame may include, in aspects, built-in LED lights facing externally or internally. These lights may be powered and controlled through a connector located on the cover frame. The LED lights may be powered and controlled by the processing unit 460.

In another aspect, the cover frame (105 in FIG. 1) may include physical buttons for the purposes of initial setup, controlling, testing, upgrading and/or troubleshooting of the processing unit 460 or overall device or system. In another aspect, the cover frame (105 in FIG. 1) may include a port(s) for wire connection(s) for the purposes of initial setup, testing, upgrading, controlling, and/or troubleshooting of the processing unit, or other purposes.

FIG. 6 shows another embodiment of a single node 640. In one embodiment, two ports 686a, 687a are connected to high voltage lines. In this example, port 686a receives high voltage power from the circuit breaker and port 687a leads to electrical load(s) on a premises. Between the input and output ports are the components of the node. In this example, a high voltage relay 642 can switch on and off electric power on a circuit-by-circuit basis. A current sensor 641 is included to measure electric current by one or more circuits and/or a voltage sensor 641 is included to measure electric voltage by one or more circuits. In an embodiment, connector 644 of each node serve to provide power to the circuit board in/on the node and its elements, as well as to transmit current sensor readings and receive on/off commands from the IC (e.g., processing unit). In another embodiment, the nodes may link or connect by way of wired or wireless communication to one or more of other nodes, controllers, or the IC (e.g., processor). For example, the nodes may be connected by one or a plurality of low voltage connection lines transmitting signals between one or more of nodes, controllers, and/or the IC (e.g., processing unit). In an aspect, a single node 640 can have a controller chip 665 to run a pre-defined software code and/or receive, send, process, store, analyze and otherwise work with information received from current and/or voltage senor(s) 641. In another aspect, the controller chip 665 can execute on/off commands, read information and/or otherwise operate the relay 642.

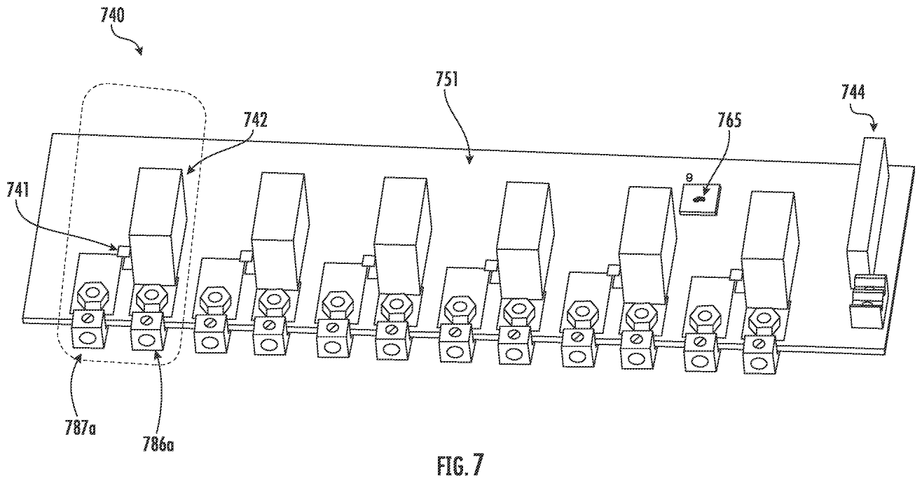

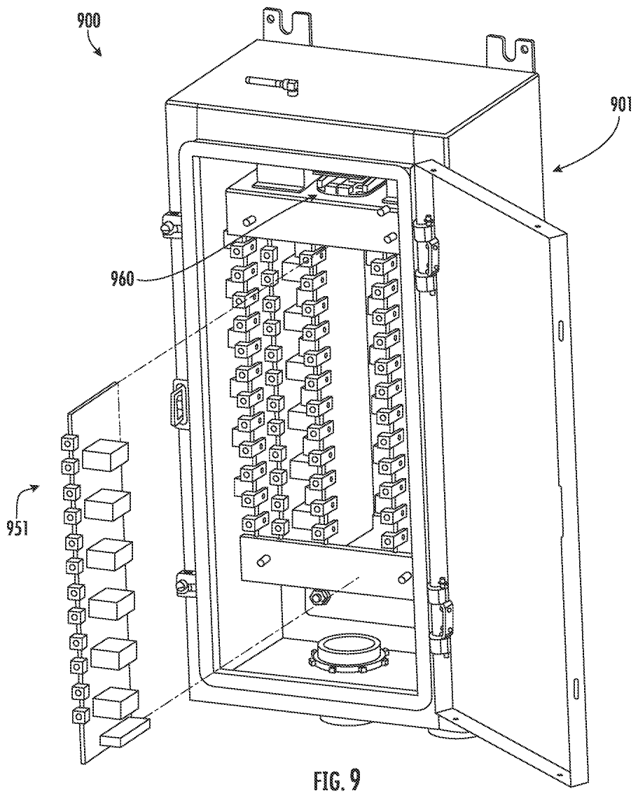

FIG. 7 shows an example group of nodes hosted on a single circuit board 751. Such nodes 740 may be in communication with one or more of other nodes, a controller 765, the IC (e.g., processing unit) (such as 960 in FIG. 9), and/or a connector port 744. Multiple nodes may be placed on a single circuit board 751 and communicate by low voltage connection lines or wirelessly with one or more of other nodes, other group(s) of nodes, other circuit board(s), a controller chip(s), or the IC (e.g., processing unit). The node may comprise the parts exemplified in FIG. 6 and FIG. 7, such as the line in 786a, relay 742, sensor(s) 741, and line out 787a. In embodiments, these boards 751 may be grouped on a back plane.

Regarding the optional controller 765, a controller is generally, in embodiments, a computer chip that runs a pre-defined software code. For example, in embodiments, unlike the IC or a processor chip that may have an operating system (e.g., Windows or Linux) where multiple tasks may be accomplished (such as using Microsoft Office applications and playing videogames), a controller may have a pre-created set of codes or algorithms, which would run them in circles or loops. For example, the code may instruct: Read a signal on Channel 1—Convert the data from analog format into digital format—Send the data to Channel 5—Go back to Reading a signal on Channel 1.

Turning back to FIG. 7, the optional controller 765 in this example reads signals generated by sensor(s) 741 placed on each individual circuit. In some aspects, the sensor(s) generates analog signal(s). In other cases, a digital signal(s) is produced or an analog signal(s) is converted into digital signal(s). In an embodiment, the controller is set to measure each circuit several thousand times per second. The controller, in this example, then converts these signals from analog to digital format. In some cases, an analog signal is relatively susceptible to noise (unlike a digital signal, which is typically binary code). Accordingly, in some cases, the closer the controller chip(s) is to the sensor(s), the better it is for the signal received by a controller or processor.

In embodiments, once the signal is received, the controller can apply certain mathematical equations to the signal. For example, the controller may calculate an average number from the thousands of readings before transmitting to the IC (processor). Other calculations may include, but are not limited to, Fourier transform, allocation of local maximums and minimums, and oversampling.

In embodiments, the controller may use certain communication protocols, such as CAN bus, Ethernet, USB, SPI. or I2C, to send the resulting data to the IC, which, in turn, has an operating system, such as Linux, and a number of applications running, such as WiFi, auto-updater, and other programs. Thus, in aspects, a controller can work with one or multiple circuits or nodes, since, in aspects, one of its functions is to perform necessary operations on the data provided by sensors. In other embodiments, a controller(s) is unnecessary because the software, applications, and/or algorithmic functionality, can be handled by the one or more IC as described herein, and/or by one or more IC/processor/software/application on a cloud-based server or remote electronic device (e.g., a phone or a computer).

FIG. 8 and FIG. 9 show other possible embodiments of the invention taught herein whereby several groupings of nodes on circuit boards (851 and 951, respectively) are configured together and placed in an enclosure (801 and 901). The groupings of nodes may have their own IC(s) or share an IC 960. In this example, if controllers are used, each grouping of nodes has or shares one controller, although in embodiments, each node may have a controller or all nodes or grouping of nodes may share one controller.

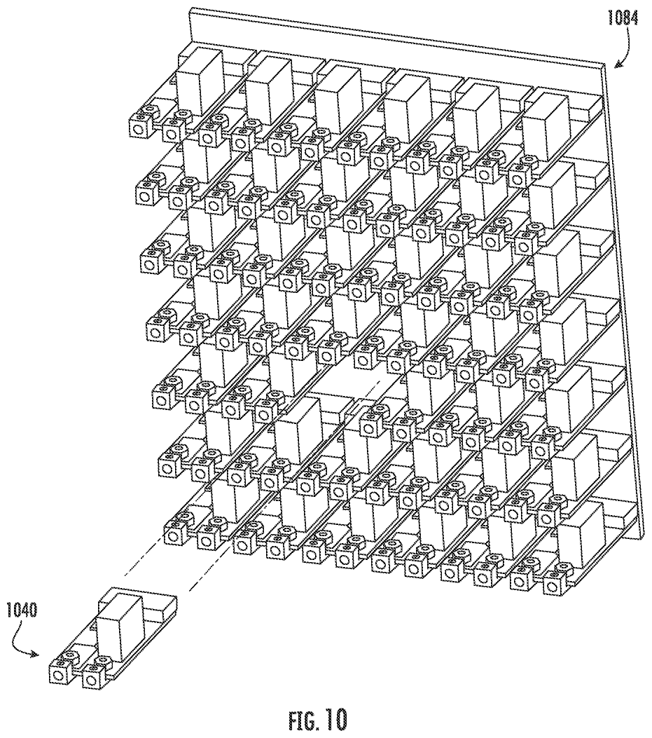

FIG. 10 shows multiple nodes 1040. Each node 1040 is connected to a single back plane 1084 in this example, which is in communication with one or more IC.

FIG. 11 shows a single node 1140 placed in an enclosure 1143. In this embodiment, the node 1140 is designed in a way to connect directly to a circuit breaker by high voltage socket/connector/lug/port/terminal 1186a and pass the electricity to a load on premises through a high voltage electrical line 1130. In this example, the high voltage line 1130 is presented by an existing wire that originally connects a circuit breaker and a load on premises. The node 1140 is connected to a communication rail by low voltage node connector 1144.

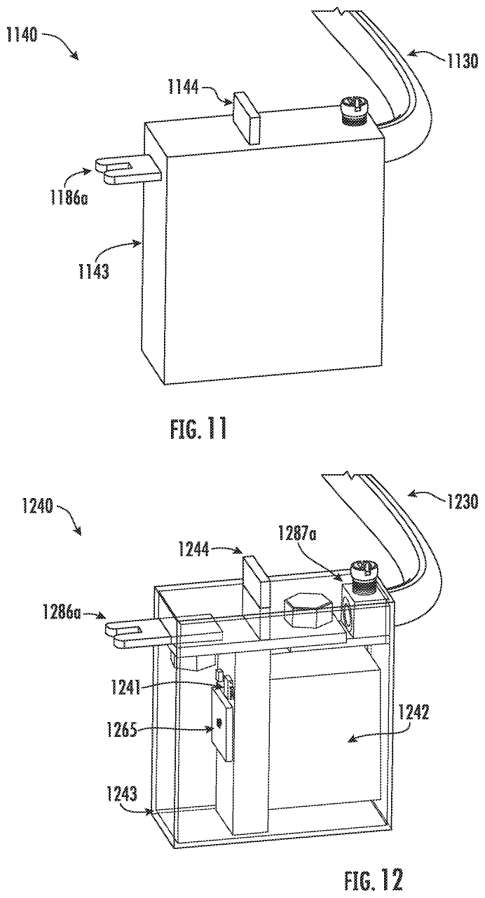

FIG. 12 shows a possible internal configuration of a single node 1240 (as shown on FIG. 11 1140) that is installed adjacent to or near a circuit breaker. In this example, the node 1240 is placed in an enclosure 1243. In this embodiment, a high voltage socket/connector/lug/port/terminal 1286a is used to connect the node 1240 to an existing circuit breaker. High voltage socket/connector/lug/port/terminal 1287a is used to connect the node 1240 to a high voltage electrical line 1230 to pass electricity to a load on a premises. A low voltage connector 1244 can be used to connect the node 1240 to a communication rail, circuit board, back plane, another node, or other aspect of the system, such as an IC. The node 1240 also contains a relay 1242 and a current and/or voltage senor 1241 to control and measure electricity flow on the electrical circuit. Readings taken by sensor(s) 1241 are communicated, received, processed, stored and/or sent by the optional controller chip 1265. The optional controller chip 1265 also can send on/off commands or otherwise interacts with the relay 1242. The optional controller chip 1265 may communicate with other nodes, groups of nodes, IC(s) or other devices by means of connection through the connector port 1244, wirelessly, by low voltage connection lines, or other forms of communicating. In other aspects, information, data, readings, measurements, commands, and/or instructions, can be sent directly between or among the current and/or voltage sensor, the relay, and the IC.

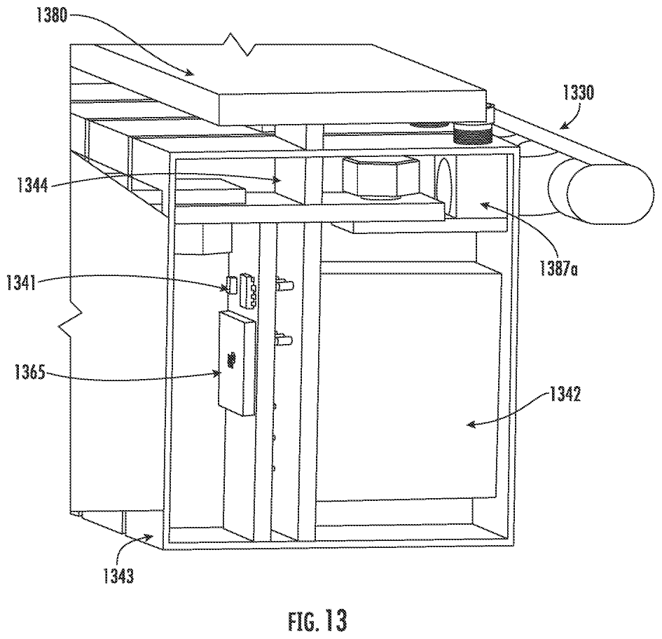

FIG. 13 shows an embodiment of a cross sectional view of the node embodiment previously demonstrated in FIG. 11 and FIG. 12. FIG. 13 illustrates previously described elements such as node enclosure 1343, current/voltage senor(s) 1341, relay 1342, low voltage connector 1344, high voltage socket/connector/lug/port/terminal 1387a and high voltage electrical line 1330. In addition, FIG. 13 demonstrates a connection rail or circuit board 1380 designed to carry low voltage signals to/from the node, such as to/from the IC, as well as to carry power needed to operate the node. In this aspect, a node is attached to the connection rail 1380 by low voltage connector 1344.

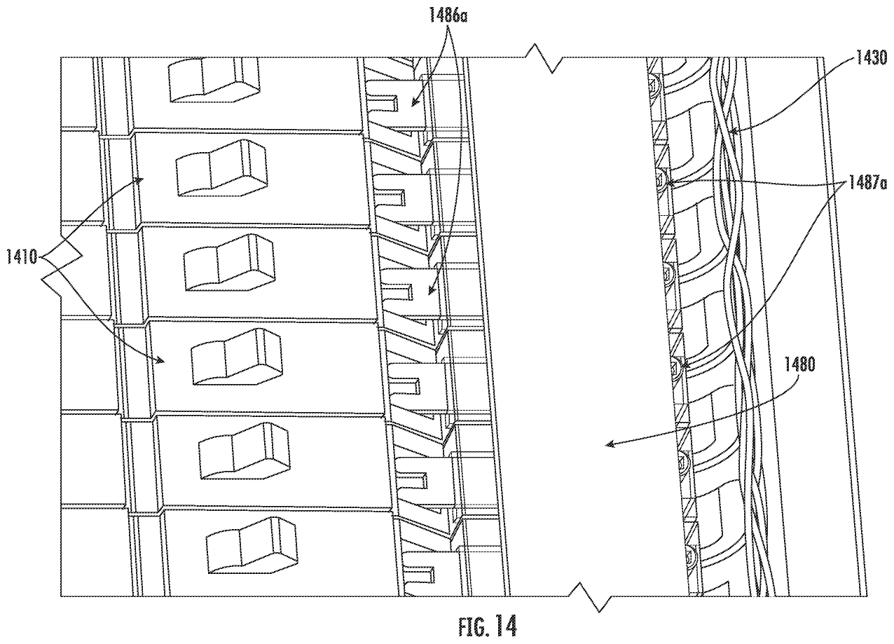

FIG. 14 shows connection rail 1480 covering and/or connected to several nodes that are attached to existing circuit breakers 1410 by high voltage socket/connector/lug/port/terminals 1486a and to high voltage electrical line 1430 by high voltage socket/connector/lug/port/terminals 1487a.

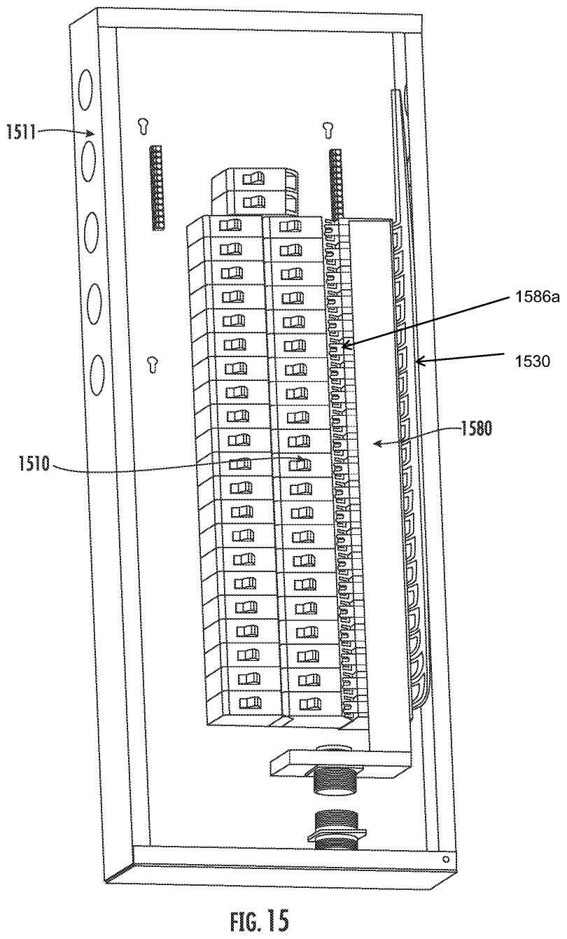

FIG. 15 shows multiple nodes installed adjacent to existing circuit breakers 1510 in an existing circuit breaker panel, and connected by connection rail 1580 covering and/or connected to said nodes. Each node can be coupled to an existing circuit breaker by high voltage socket/connector/lug/port/terminals 1586a and to electrical loads on a premises by high voltage electrical line 1530.

FIG. 16 shows another possible configuration of the device. This example shows the containing unit 1601 installed adjacent to an existing circuit breaker panel 1611. Nodes 1640 can be installed in one or more vertical rows (only one row is shown populated in FIG. 16 for demonstration purposes only) resembling a standard circuit breaker panel layout. Each node 1640 can be attached to a node pad 1685 located on a back plane 1680.

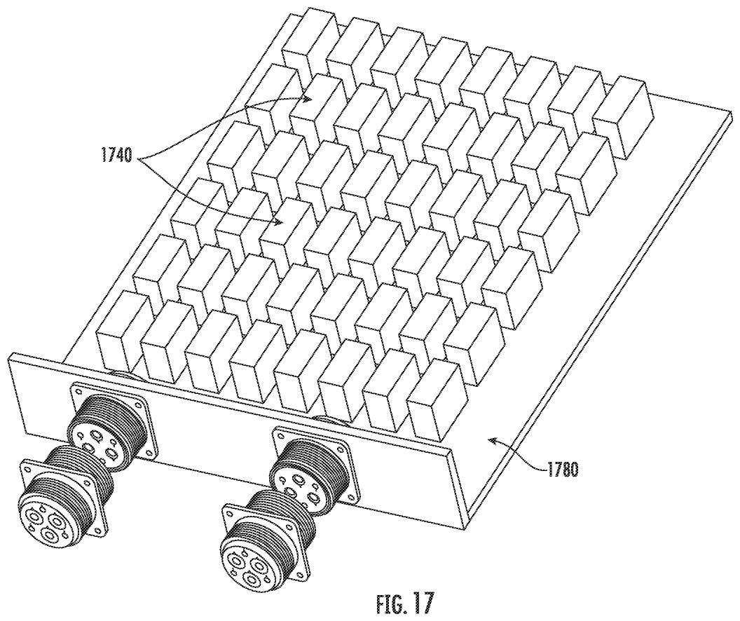

FIG. 17 shows another possible configuration of node placement wherein a single back plane 1780 is populated with individual nodes 1740.

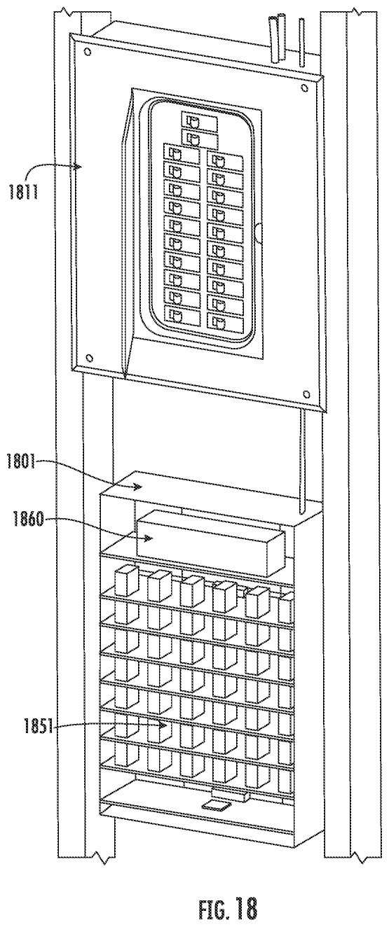

FIG. 18 shows different arrangements and possible connections to an existing circuit breaker panel 1811. In this embodiment, the containing unit 1801 is installed under the existing circuit breaker panel 1811. The containing unit 1801 is populated with groups of nodes hosted on one or more circuit boards 1851 and an IC (e.g., processing unit) 1860. A sample electric wiring is demonstrated to show connection or coupling of the apparatus to the existing circuit breaker box 1811.

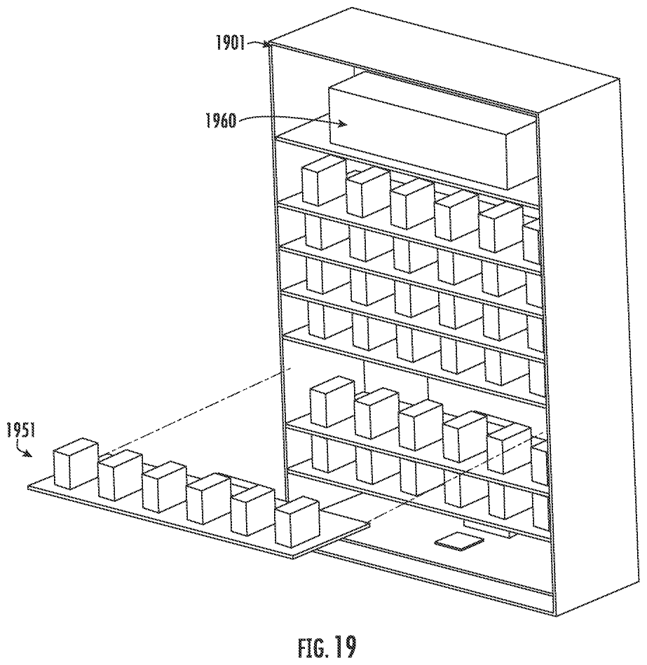

FIG. 19 shows the embodiment of the apparatus previously demonstrated in FIG. 18 in more detail. In particular, it illustrates groups of nodes hosted on a single circuit board 1951 and placed into a containing unit or housing 1901, as well as placement of the IC (e.g., processing unit) 1960.

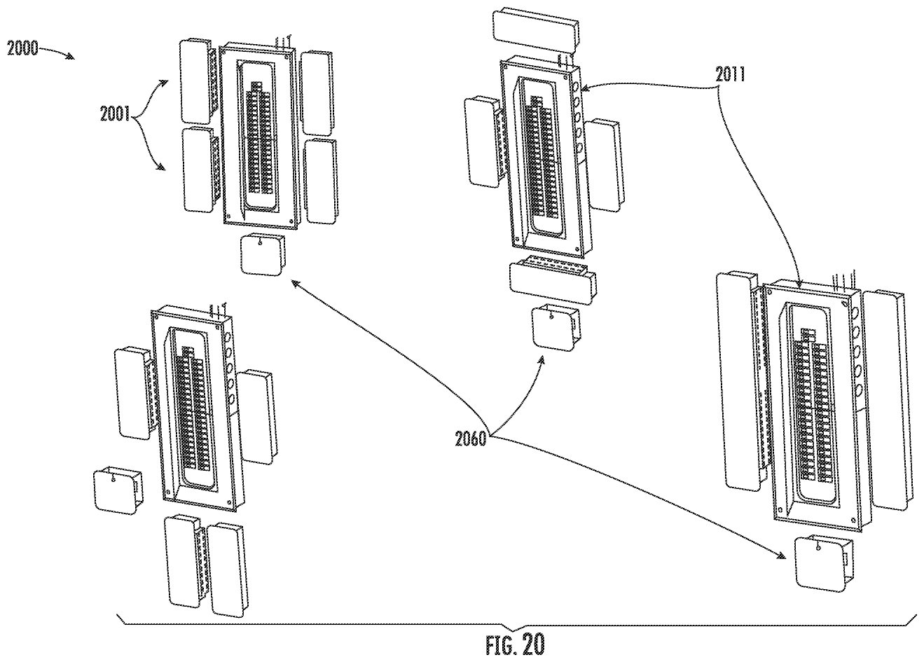

FIG. 20 shows several possible configurations of nodes, optional controllers, and ICs (processing units) as placed in and around an existing circuit breaker panel 2011, or otherwise connected to/coupled to a circuit breaker panel either wirelessly or by wired connection. Each separate aspect of the configurations may include one or more of one or more nodes, one or more controllers, and/or one or more ICs. Alternatively, each separate grouping may include one or more of one or more nodes, one controller, and/or one or more IC. Each separate groupings of one or more nodes may include one or more optional controllers, and one IC. The groupings of nodes may also share one or more optional controllers or ICs. The groupings of nodes may also share one optional controller. The groupings of nodes may also share one IC. Units of one or more nodes, one or more optional controllers, and/or one or more ICs may be separated and either wirelessly or by wired connection connected/coupled together and/or with the circuit breaker panel. The illustrated examples demonstrate placements of an IC 2060 and multiple containing units/housings 2001.

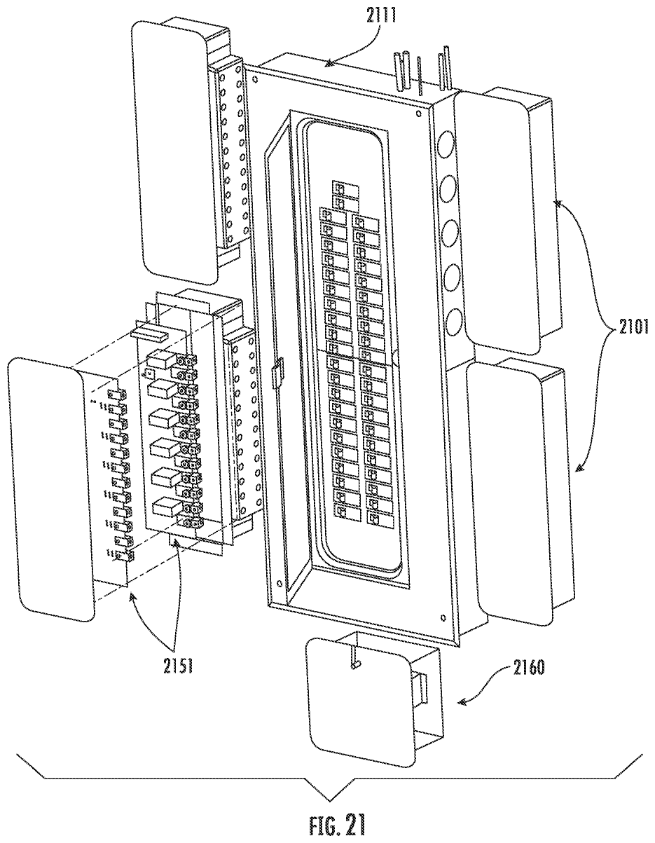

FIG. 21 depicts one of the possible configurations of nodes, optional controllers, and IC represented in FIG. 20. In this embodiment, the IC/processing unit 2160 is separated from multiple containing units 2101 near or adjacent to the existing circuit breaker panel 2111. Each containing unit/housing 2101, in this example, hosts two groups of nodes placed on a single circuit board 2151. Each containing unit/housing may be structurally, mechanically, and/or electrically coupled to the circuit breaker panel.

FIG. 22 represents another possible configuration of the apparatus 2200 designed for placement in a base frame 2201 with a lid 2205. An example of an IC/processing unit 2260 and circuit board 2251 with nodes is also depicted in the containing unit 2201 of FIG. 22.

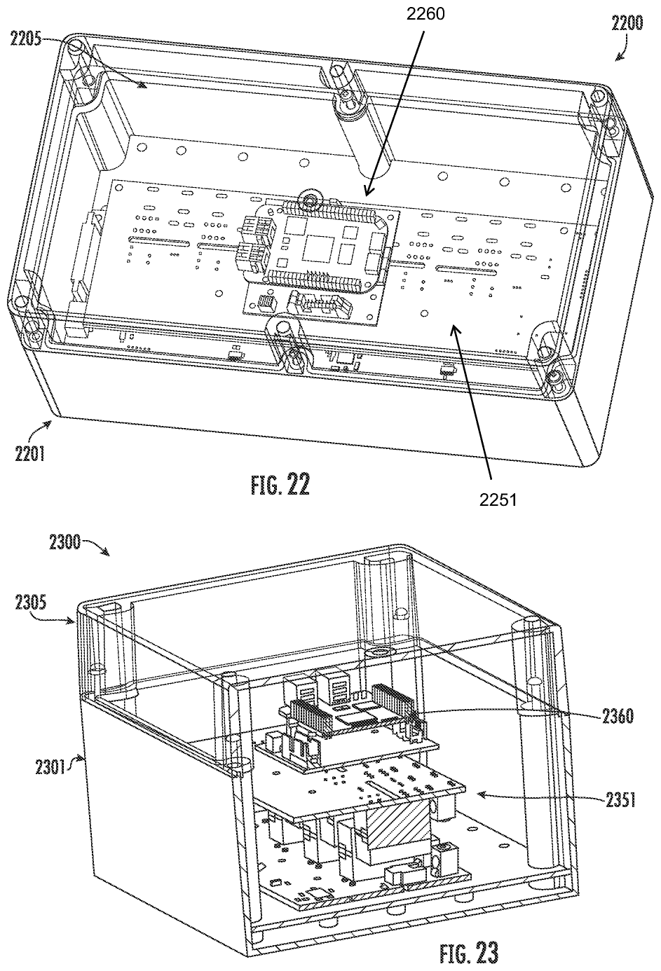

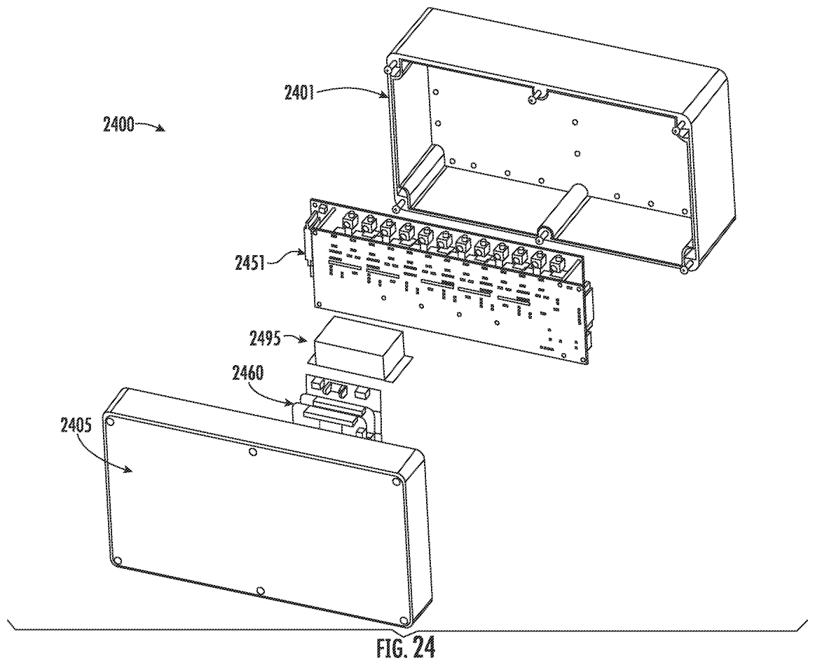

FIG. 23 shows a cross sectional view of the configuration of the apparatus 2300 (demonstrated as 2200 in FIG. 22). In this embodiment, groups of nodes are hosted on a single circuit board 2351 and, along with an IC/processing unit 2360, are placed into the base frame 2301 and covered with a lid 2305.

FIG. 24 shows an exploded view of the apparatus 2400 (demonstrated as 2200 in FIGS. 22 and 2300 in FIG. 23). The base frame 2401 hosts groups of nodes on a single circuit board 2451, battery 2495, and IC/processing unit 2460. The components are covered with the lid 2405.

FIG. 25 shows a connection unit, base, or bar 2596, whereby the invention as taught herein is connected directly to the circuits 2510 on a circuit breaker panel, thereby facilitating connection of the invention taught herein to a circuit breaker panel.

In aspects, a system embodiment of the invention has physical and virtual integration between system components, including a PV inverter, ESS charge controller, ESS, SPLP, and load-side demand.

SPLP systems according to embodiments of the invention can be used in connection/cooperation with an ESS to provide for management and control of power/energy from a power/energy source, such as a rechargeable battery. For example, a battery can be charged by way of a rooftop PV array or other energy generation source. Power from the power source, such as a battery or storage system, can be passed through the SPLP into a home for use in supplying the energy needs for various electrical loads.

The technology is capable of communicating in near-real-time with various existing technologies in order to achieve novel functionality. The systems comprise robust integration (both physical wiring and virtual API connection). Complete system integration can enable the SPLP to create an ecosystem of technologies that has functionality greater than the sum of its parts, which will drive up the value of the other existing technologies, energy storage technology and distributed-generation energy sources.

The SPLP system is in operable communication with an electrical load, such as a household load, one or more ESS, and/or one or more solar PV inverter. The system is configured such that API calls can be established among one or more or all devices in the system. In embodiments, the SPLP is connected with a user portal with the ESS in real time, in order to display information such as ESS charge (% and kWh), expected ESS duration, and ESS charge status (i.e. charging, not charging). The system is integrated with a source of weather data, including construction of an API, which can provide for predictive analytics.

The associated (or cloud-based) software provides algorithms, predictive analytics, and controls necessary to ensure proper functioning of the SPLP. Algorithms of the invention can be configured to correctly identify and interpret appliance modes of operation. For example, information from sensors can be input into the algorithms to determine the operating status of an appliance (e.g., 130 W from refrigerator=open door, 1,800 W=compressor engagement, etc).

A user portal is also included to allow users to interact with the SPLP, including a method of interactive user input and software response. Appliance modes can be defined to offer recommended modes of operation to the user, based on observed energy consumption patterns and other factors. The user portal can be constructed to include various modes of operation. A system of interactive user notifications can also be included to allow users to receive a notification for example via text, email or phone, respond to the notification on the same platform, and ensure that the software reacts accordingly. A user preferences tab can also be included to allow users to enter preferences based on varying outage scenarios.

Feedback mechanisms can be included and accessed through the user interface to explain which circuits are available to the user given their preference set. The systems can be configured to predict hourly PV output up to at least 24 hours in advance, with the goal of using that information to ensure that the SPLP accounts for future available energy when estimating the duration of ESS charge and energizing circuits accordingly. The systems can be configured to predict 24-hour PV output by geography and/or weather forecast. The systems can be configured to predict such forecasts in a timely and accurate fashion. Such SPLPs are forward looking and capable of anticipating and responding to near-term events.

Temporal options can also be built into the user portal, allowing users to set short, medium, and long-term operation preferences. Temporal operation preferences have a large impact on the logic governing which circuits to energize and can be configured to play a large role in the function of the SPLP. Logic can be incorporated into the systems to allow for adjustment of the length of operation based on the user input, and to ensure that circuits react accordingly.

The system can also be configured to identify branch appliances (appliances on branch circuits) with known inputs. Such capability can allow users to energize individual appliances on non-dedicated circuits during grid outages. The capability to identify branch appliances with unknown inputs can also be included. Such capabilities can include training machine learning models to isolate individual appliances form branch circuits. The systems can be configured to isolate individual appliances on branch circuits and determine modes of operation. As such, the SPLP is capable of energizing appliances on branch (non-dedicated) circuits. The systems can be configured such that the SPLP offers access to every appliance in a home during a grid outage, regardless of circuit type.

The systems can comprise interactive user portal software capable of ingesting user preferences based on modes of operation. The portal can be configured to provide for display of all requisite, desired, or selected information and to provide a menu of options by mode of operation (e.g., “if you want to use your stove, you may use up to two burners”). The systems can be configured to store user preferences for different outage scenarios—tornado warning, hurricane approaching, ice storm, etc. As outages occur, SPLP and ESS react according to cause. Such a system is thus capable of reacting to real-time events, whereby the SPLP is capable of responding in near-real-time to user preferences, consumption, output, and/or ESS charge.

In embodiments, entire neighborhoods or otherwise grouped homes (not limited to geographic concentration) can be outfitted with SPLP technology in for example 100 or more homes. In such case, distributed SPLP-enabling devices may be combined in aggregate into a single user interface or outward-facing portal.

The invention comprises several Aspects as disclosed herein:

Aspect 1—A system for managing energy consumption comprising:
one or more electrical and/or mechanical connection for connecting one or more circuit board to one or more circuit breaker and/or one or more circuit breaker panel, the one or more circuit board including at least one node connected to the one or more circuit breaker and to one or more electrical load, the at least one node including at least one voltage or current sensor and at least one relay;
one or more integrated circuit chip (“IC”) in communication with both the at least one voltage or current sensor and the at least one relay, the at least one relay configurable to be changed from an open position or an off state to a closed position or an on state, and the at least one relay configurable to be changed from the closed position or the on state to the open position or the off state; and
one or more link for wired or wireless communication with the one or more IC, the one or more IC, in response to executable instructions, operative to:
   receive sensor information from the at least one voltage or current sensor;
   transmit the sensor information from the at least one voltage or current sensor to a system user, wherein the sensor information is at least one of a raw format or a processed format;
   receive user input from the system user, the user input including instructions to turn on or off electricity supplied to the one or more electrical load by instructing the at least one relay based on the system user input to change from the closed position or the on state to the open position or the off state or from the open position or the off state to the closed position or the on state.

Aspect 2—The system for managing energy consumption of Aspect 1, wherein the node further includes an electromechanical bypass to change the relay from the closed position or the on state to the open position or the off state, to change the relay from the open position or the off state to the closed position or the on state, or to lock the relay in the open position or the off state or the closed position or the on state, regardless of instructions received from the one or more IC.

Aspect 3—The system for managing energy consumption of Aspect 1, wherein the one or more IC is located separate from the one or more circuit board.

Aspect 4—The system for managing energy consumption of Aspect 1, wherein the one or more IC is located in at least one of a solar inverter, an inverter, an energy storage system, a gateway device, a battery, a smart thermostat, an electric vehicle charger, an electric vehicle, an internet of things (“IoT”) enabled device, a server, a computer, a computer processing unit, or another system for managing energy consumption.

Aspect 5—The system for managing energy consumption of Aspect 1, wherein the one or more IC comprises at least two ICs, a first IC in communication with the at least one voltage or current sensor, and a second IC in communication with the at least one relay.

Aspect 6—A system for managing energy consumption comprising:
one or more electrical and/or mechanical connection for connecting one or more circuit board to one or more circuit breaker and/or one or more circuit breaker panel, the one or more circuit board including at least one node connected to the one or more circuit breaker and to one or more electrical load, the at least one node including at least one voltage or current sensor and at least one relay;
one or more integrated circuit chip (“IC”) in communication with both the at least one voltage or current sensor and the at least one relay, the at least one relay configurable to be changed from an open position or an off state to a closed position or an on state and the at least one relay configurable to be changed from the closed position or the on state to the open position or the off state; and
one or more link for wired or wireless communication with the one or more IC, the one or more IC, in response to executable instructions, operative to:
   receive a voltage or current sensor reading from the at least one voltage or current sensor;
   determine whether to turn off the one or more electrical load if the voltage or current sensor reading received from the at least one voltage or current sensor exceeds a pre-programmed upper limit energy consumption value for the one or more electrical load; and
   send one or more command to the at least one relay based on the determination whether to turn off the one or more electrical load, wherein the one or more command instructs the at least one relay to change from the closed position or the on state to the open position or the off state.

Aspect 7—The system for managing energy consumption of Aspect 6, wherein the node further includes an electromechanical bypass to change the relay from the closed position or the on state to the open position or the off state, to change the relay from the open position or the off state to the closed position or the on state, or to lock the relay in the open position or the off state or the closed position or the on state, regardless of instructions received from the one or more IC.

Aspect 8—The system for managing energy consumption of Aspect 6, wherein the one or more IC is located separate from the one or more circuit board.

Aspect 9—The system for managing energy consumption of Aspect 6, wherein the one or more IC is located in at least one of a solar inverter, an inverter, an energy storage system, a gateway device, a battery, a smart thermostat, an electric vehicle charger, an electric vehicle, an internet of things (“IoT”) enabled device, a server, a computer, a computer processing unit, or another system for managing energy consumption.

Aspect 10—The system for managing energy consumption of Aspect 6, wherein the one or more IC comprises at least two ICs, a first IC in communication with the at least one voltage or current sensor, and a second IC in communication with the at least one relay.

Aspect 11—A system for managing energy consumption comprising:
one or more electrical and/or mechanical connection for connecting one or more circuit board to one or more circuit breaker and/or one or more circuit breaker panel, the one or more circuit board including at least one node connected to the one or more circuit breaker and to one or more electrical load, the at least one node including at least one voltage or current sensor and at least one relay;
one or more integrated circuit chip (“IC”) in communication with both the at least one voltage or current sensor and the at least one relay, the at least one relay configurable to be changed from an open position or an off state to a closed position or an on state and the at least one relay configurable to be changed from the closed position or the on state to the open position or the off state; and
one or more link for wired or wireless communication with the one or more IC, the one or more IC, in response to executable instructions, operative to:
   receive a voltage or current sensor reading from the at least one voltage or current sensor;
   translate the voltage or current sensor reading to at least one of a monetary value of energy being consumed by the one or more electrical load, a predicted monetary value of energy being consumed by the one or more electrical load, and a predicted monetary value of energy that will be consumed by the one or more electrical load;
   determine whether to turn off the one or more electrical load if one or more of the at least one of the monetary value of energy being consumed by the one or more electrical load, the predicted monetary value of energy being consumed by the one or more electrical load, and the predicted monetary value of energy that will be consumed by the one or more electrical load, exceed a pre-programmed upper limit monetary value; and
   send one or more command to the at least one relay based on the determination whether to turn off the one or more electrical load, wherein the one or more command instructs the at least one relay to change from the closed position or the on state to the open position or the off state.

Aspect 12—The system for managing energy consumption of Aspect 11, wherein the node further includes an electromechanical bypass to change the relay from the closed position or the on state to the open position or the off state, to change the relay from the open position or the off state to the closed position or the on state, or to lock the relay in the open position or the off state or the closed position or the on state, regardless of instructions received from the one or more IC.

Aspect 13—The system for managing energy consumption of Aspect 11, wherein the one or more IC is located separate from the one or more circuit board.

Aspect 14—The system for managing energy consumption of Aspect 11, wherein the one or more IC is located in at least one of a solar inverter, an inverter, an energy storage system, a gateway device, a battery, a smart thermostat, an electric vehicle charger, an electric vehicle, an internet of things (“IoT”) enabled device, a server, a computer, a computer processing unit, or another system for managing energy consumption.

Aspect 15—The system for managing energy consumption of Aspect 11, wherein the one or more IC comprises at least two ICs, a first IC in communication with the at least one voltage or current sensor, and a second IC in communication with the at least one relay.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Any of the methods disclosed herein can be used with any of the compositions disclosed herein or with any other compositions. Likewise, any of the disclosed compositions can be used with any of the methods disclosed herein or with any other methods. Other embodiments of the invention will be apparent to those skilled in the art from consideration of the specification and practice of the invention.

It is noted in particular that where a range of values is provided in this specification, each value between the upper and lower limits of that range, to the tenth of the unit disclosed, is also specifically disclosed. Any smaller range within the ranges disclosed or that can be derived from other endpoints disclosed are also specifically disclosed themselves. The upper and lower limits of disclosed ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

As used herein, the term “about” refers to plus or minus 5 units (e.g., percentage) of the stated value.

Reference in the specification to, e.g., “some embodiments,” “an embodiment,” “one embodiment,” or “other embodiments” means that a particular feature, structure, or characteristic described in connection with the embodiments is included in at least some embodiments, but not necessarily all embodiments, of the inventions.

As used herein, the term “substantial” and “substantially” refers to what is easily recognizable to one of ordinary skill in the art.

It is to be understood that the phraseology and terminology employed herein is not to be construed as limiting and are for descriptive purpose only.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

1) A system for managing energy consumption comprising:
one or more electrical and/or mechanical connection for connecting one or more circuit board to one or more circuit breaker and/or one or more circuit breaker panel, the one or more circuit board including at least one node connected to the one or more circuit breaker and to one or more electrical load, the at least one node including at least one voltage or current sensor and at least one relay;
one or more integrated circuit chip (“IC”) in communication with both the at least one voltage or current sensor and the at least one relay, the at least one relay configurable to be changed from an open position or an off state to a closed position or an on state, and the at least one relay configurable to be changed from the closed position or the on state to the open position or the off state; and
one or more link for wired or wireless communication with the one or more IC, the one or more IC, in response to executable instructions, operative to:
receive sensor information from the at least one voltage or current sensor;
transmit the sensor information from the at least one voltage or current sensor to a system user, wherein the sensor information is at least one of a raw format or a processed format;
receive user input from the system user, the user input including instructions to turn on or off electricity supplied to the one or more electrical load by instructing the at least one relay based on the system user input to change from the closed position or the on state to the open position or the off state or from the open position or the off state to the closed position or the on state.

2) The system for managing energy consumption of claim 1, wherein the node further includes an electromechanical bypass to change the relay from the closed position or the on state to the open position or the off state, to change the relay from the open position or the off state to the closed position or the on state, or to lock the relay in the open position or the off state or the closed position or the on state, regardless of instructions received from the one or more IC.

3) The system for managing energy consumption of claim 1, wherein the one or more IC is located separate from the one or more circuit board.

4) The system for managing energy consumption of claim 1, wherein the one or more IC is located in at least one of a solar inverter, an inverter, an energy storage system, a gateway device, a battery, a smart thermostat, an electric vehicle charger, an electric vehicle, an internet of things (“IoT”) enabled device, a server, a computer, a computer processing unit, or another system for managing energy consumption.

5) The system for managing energy consumption of claim 1, wherein the one or more IC comprises at least two ICs, a first IC in communication with the at least one voltage or current sensor, and a second IC in communication with the at least one relay.

6) A system for managing energy consumption comprising:
one or more electrical and/or mechanical connection for connecting one or more circuit board to one or more circuit breaker and/or one or more circuit breaker panel, the one or more circuit board including at least one node connected to the one or more circuit breaker and to one or more electrical load, the at least one node including at least one voltage or current sensor and at least one relay;
one or more integrated circuit chip (“IC”) in communication with both the at least one voltage or current sensor and the at least one relay, the at least one relay configurable to be changed from an open position or an off state to a closed position or an on state and the at least one relay configurable to be changed from the closed position or the on state to the open position or the off state; and
one or more link for wired or wireless communication with the one or more IC, the one or more IC, in response to executable instructions, operative to:
receive a voltage or current sensor reading from the at least one voltage or current sensor;
determine whether to turn off the one or more electrical load if the voltage or current sensor reading received from the at least one voltage or current sensor exceeds a pre-programmed upper limit energy consumption value for the one or more electrical load; and
send one or more command to the at least one relay based on the determination whether to turn off the one or more electrical load, wherein the one or more command instructs the at least one relay to change from the closed position or the on state to the open position or the off state.

7) The system for managing energy consumption of claim 6, wherein the node further includes an electromechanical bypass to change the relay from the closed position or the on state to the open position or the off state, to change the relay from the open position or the off state to the closed position or the on state, or to lock the relay in the open position or the off state or the closed position or the on state, regardless of instructions received from the one or more IC.

8) The system for managing energy consumption of claim 6, wherein the one or more IC is located separate from the one or more circuit board.

9) The system for managing energy consumption of claim 6, wherein the one or more IC is located in at least one of a solar inverter, an inverter, an energy storage system, a gateway device, a battery, a smart thermostat, an electric vehicle charger, an electric vehicle, an internet of things (“IoT”) enabled device, a server, a computer, a computer processing unit, or another system for managing energy consumption.

10) The system for managing energy consumption of claim 6, wherein the one or more IC comprises at least two ICs, a first IC in communication with the at least one voltage or current sensor, and a second IC in communication with the at least one relay.

11) A system for managing energy consumption comprising:
one or more electrical and/or mechanical connection for connecting one or more circuit board to one or more circuit breaker and/or one or more circuit breaker panel, the one or more circuit board including at least one node connected to the one or more circuit breaker and to one or more electrical load, the at least one node including at least one voltage or current sensor and at least one relay;
one or more integrated circuit chip (“IC”) in communication with both the at least one voltage or current sensor and the at least one relay, the at least one relay configurable to be changed from an open position or an off state to a closed position or an on state and the at least one relay configurable to be changed from the closed position or the on state to the open position or the off state; and
one or more link for wired or wireless communication with the one or more IC, the one or more IC, in response to executable instructions, operative to:
receive a voltage or current sensor reading from the at least one voltage or current sensor;
translate the voltage or current sensor reading to at least one of a monetary value of energy being consumed by the one or more electrical load, a predicted monetary value of energy being consumed by the one or more electrical load, and a predicted monetary value of energy that will be consumed by the one or more electrical load;
determine whether to turn off the one or more electrical load if one or more of the at least one of the monetary value of energy being consumed by the one or more electrical load, the predicted monetary value of energy being consumed by the one or more electrical load, and the predicted monetary value of energy that will be consumed by the one or more electrical load, exceed a pre-programmed upper limit monetary value; and
send one or more command to the at least one relay based on the determination whether to turn off the one or more electrical load, wherein the one or more command instructs the at least one relay to change from the closed position or the on state to the open position or the off state.

12) The system for managing energy consumption of claim 11, wherein the node further includes an electromechanical bypass to change the relay from the closed position or the on state to the open position or the off state, to change the relay from the open position or the off state to the closed position or the on state, or to lock the relay in the open position or the off state or the closed position or the on state, regardless of instructions received from the one or more IC.

13) The system for managing energy consumption of claim 11, wherein the one or more IC is located separate from the one or more circuit board.

14) The system for managing energy consumption of claim 11, wherein the one or more IC is located in at least one of a solar inverter, an inverter, an energy storage system, a gateway device, a battery, a smart thermostat, an electric vehicle charger, an electric vehicle, an internet of things (“IoT”) enabled device, a server, a computer, a computer processing unit, or another system for managing energy consumption.

15) The system for managing energy consumption of claim 11, wherein the one or more IC comprises at least two ICs, a first IC in communication with the at least one voltage or current sensor, and a second IC in communication with the at least one relay.
